(19) United States
(12) Patent Application Publication
(10) Pub. No.: US 2009/0094053 A1
(43) Pub. Date: Apr. 9, 2009

(54) DIAGNOSIS THROUGH GRAPHICAL REPRESENTATION OF PATIENT CHARACTERISTICS

(76) Inventors: Edward Jung, Bellevue, WA (US); Eric C. Leuthardt, St. Louis, MO (US); Royce A. Levien, Lexington, MA (US); Robert W. Lord, Seattle, WA (US); Nathan P. Myhrvold, Medina, WA (US); Charles Whitmer, North Bend, WA (US); Lowell L. Wood, JR., Bellevue, WA (US)

Correspondence Address: BRAKE HUGHES BELLERMANN LLP, c/o CPA Global, P.O. BOX 52050, MINNEAPOLIS, MN, 55402, US

(21) Appl. No.: 11/869,413

(22) Filed: Oct. 9, 2007

(51) Int. Cl. G06Q 50/00

(52) U.S. Cl. 705/2

(57) ABSTRACT

An apparatus, device, methods, computer program product, and systems are described that receive at least one set of diagnosis parameters associated with one or more patients, determine one or more spider charts associated with one or more potential diagnoses for the one or more patients, and provide the one or more spider charts in visual proximity to one another.

### SUMMARY

An embodiment provides a method. In one implementation, the method includes but is not limited to receiving at least one set of diagnosis parameters associated with one or more patients, determining one or more spider charts associated with one or more potential diagnoses for the one or more patients, and providing the one or more spider charts in visual proximity to one another. In addition to the foregoing, other method aspects are described in the claims, drawings, and text forming a part of the present disclosure.

An embodiment provides a computer program product. In one implementation, the computer program product includes but is not limited to a signal-bearing medium bearing one or more instructions for receiving at least one set of diagnosis parameters associated with one or more patients. The signal bearing medium also may bear one or more instructions for determining one or more spider charts associated with one or more potential diagnoses for the one or more patients. The signal bearing medium also may bear one or more instructions for providing the one or more spider charts in visual proximity to one another. In addition to the foregoing, other computer program product aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

An embodiment provides a system, the system including a computing device including computer-executable instructions that when executed on the computing device, cause the computing device to receive at least one set of diagnosis parameters associated with one or more patients, determine one or more spider charts associated with one or more potential diagnoses for the one or more patients, and provide the one or more spider charts in visual proximity to one another. In addition to the foregoing, other system aspects are described in the claims, drawings, and text forming a part of the present disclosure.

An embodiment provides a diagnosis system, the diagnosis system comprising a parameter handler configured to receive at least one set of diagnosis parameters associated with one or more patients, a spider chart generator configured to determine one or more spider charts associated with one or more potential diagnoses for the one or more patients, and a view generator configured to provide the one or more spider charts in visual proximity to one another. In addition to the foregoing, other system aspects are described in the claims, drawings, and text forming a part of the present disclosure.

An embodiment provides a method. In one implementation, the method includes but is not limited to receiving at least one set of diagnosis parameters associated with one or more physiological characteristics of one or more patients, determining one or more spider charts associated with one or more potential diagnoses related to one or more physical ailments of the one or more patients, and providing the one or more spider charts in visual proximity to one another. In addition to the foregoing, other method aspects are described in the claims, drawings, and text forming a part of the present disclosure.

An embodiment provides a computer program product. In one implementation, the computer program product includes but is not limited to a signal-bearing medium bearing one or more instructions for receiving at least one set of diagnosis parameters associated with one or more physiological characteristics of one or more patients. The signal bearing medium also may bear one or more instructions for determining one or more spider charts associated with one or more potential diagnoses related to one or more physical ailments of the one or more patients. The signal bearing medium also may bear one or more instructions for providing the one or more spider charts in visual proximity to one another. In addition to the foregoing, other computer program product aspects are described in the claims, drawings, and text forming a part of the present disclosure.

An embodiment provides a system, the system including a computing device including computer-executable instructions that when executed on the computing device, cause the computing device to receive at least one set of diagnosis parameters associated with one or more physiological characteristics of one or more patients, determine one or more spider charts associated with one or more potential diagnoses related to one or more physical ailments of the one or more patients, and provide the one or more spider charts in visual proximity to one another. In addition to the foregoing, other system aspects are described in the claims, drawings, and text forming a part of the present disclosure.

An embodiment provides a diagnosis system, the diagnosis system comprising a parameter handler configured to receive at least one set of diagnosis parameters associated with one or more physiological characteristics of one or more patients, a spider chart generator configured to determine one or more spider charts associated with one or more potential diagnoses related to one or more physical ailments of the one or more patients, and a view generator configured to provide the one or more spider charts in visual proximity to one another. In addition to the foregoing, other system aspects are described in the claims, drawings, and text forming a part of the present disclosure.

In addition to the foregoing, various other embodiments are set forth and described in the text (e.g., claims and/or detailed description) and/or drawings of the present description.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE DRAWINGS

FIG. 1 illustrates an example clinical system in which embodiments may be implemented, perhaps in a device, to perform diagnosis through graphical representations of patient characteristics.

FIG. 2 illustrates examples of the graphical representations of FIG. 1 in which the graphical representations include one or more spider charts.

FIG. 3 illustrates an operational flow representing example operations related to diagnosis through graphical representations of patient characteristics.

FIG. 4 illustrates an alternative embodiment of the example operational flow of FIG. 3.

FIG. 5 illustrates an alternative embodiment of the example operational flow of FIG. 3.

FIG. 6 illustrates an alternative embodiment of the example operational flow of FIG. 3.

FIG. 7 illustrates an alternative embodiment of the example operational flow of FIG. 3.

FIG. 8 illustrates an alternative embodiment of the example operational flow of FIG. 3.

FIG. 9 illustrates an alternative embodiment of the example operational flow of FIG. 3.

FIG. 10 illustrates an alternative embodiment of the example operational flow of FIG. 3.

FIG. 11 illustrates an alternative embodiment of the example operational flow of FIG. 3.

FIG. 12 illustrates an alternative embodiment of the example operational flow of FIG. 3.

FIG. 13 illustrates an alternative embodiment of the example operational flow of FIG. 3.

FIG. 14 illustrates an alternative embodiment of the example operational flow of FIG. 3.

FIG. 15 illustrates an alternative embodiment of the example operational flow of FIG. 3.

FIG. 16 illustrates an alternative embodiment of the example operational flow of FIG. 3.

FIG. 17 illustrates a partial view of an example computer program product that includes a computer program for executing a computer process on a computing device.

FIG. 18 illustrates an example system in which embodiments may be implemented.

FIG. 19 illustrates another example operational flow representing example operations related to diagnosis through graphical representations of patient characteristics.

FIG. 20 illustrates a partial view of an example computer program product that includes a computer program for executing a computer process on a computing device.

FIG. 21 illustrates an example system in which embodiments may be implemented.

The use of the same symbols in different drawings typically indicates similar or identical items.

### DETAILED DESCRIPTION

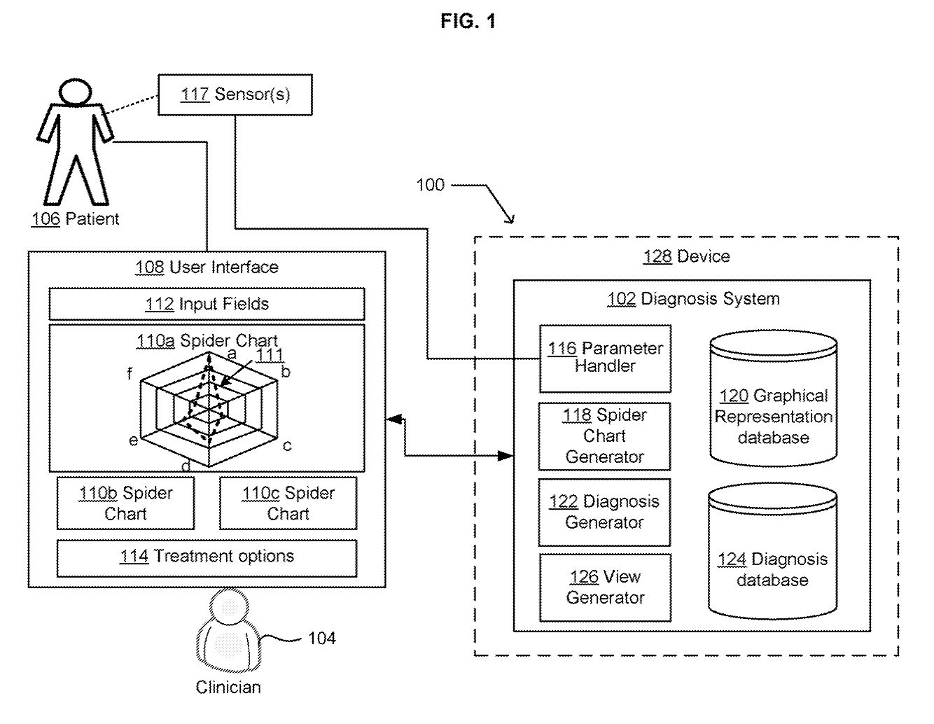

FIG. 1 illustrates an example clinical system 100 in which embodiments may be implemented, perhaps in a device, to perform diagnosis through graphical representation of patient characteristics. The clinical system 100 includes a diagnosis system 102. The diagnosis system 102 may be used, for example, to determine a diagnosis for one or more patients, based at least in part on graphical representations associated with the diagnosis and/or with the one or more patients. Basing the diagnosis on such graphical representations may allow, for example, effective use of a visual perception or recognition of the diagnosis from among multiple possible diagnoses. Consequently, diagnoses may be made quickly, effectively, and accurately.

In FIG. 1, the diagnosis system 102 may be used by a clinician 104. The clinician 104 may, for example, use the diagnosis system 102 to enter, store, request, process, or access clinical information such as, for example, the various examples provided herein. The clinician 104 may generally represent, for example, any person involved in health care, including, for example, a doctor, a nurse, a physician's assistant, or a medical researcher. The clinician 104 also may represent someone who is involved in health care in the sense of developing, managing, or implementing the diagnosis system 102, e.g., a software developer with clinical knowledge (or access to clinical knowledge), a database manager, or an information technologies specialist. Even more generally, some or all of various functions or aspects described herein with respect to the clinician 104 may be performed automatically, e.g., by an appropriately-designed and implemented computing device, or by software agents or other automated techniques.

A patient 106 generally represents one or more persons with an illness, injury, or disease, or who is thought potentially to have such an illness, injury, or disease, or who may be wholly or partially healthy but who is nonetheless studied in order to determine information about such an illness, injury, or disease. The patient 106 also may represent or include other diagnostic and/or animal subjects that may be used in order, for example, to determine an efficacy of a particular medication or treatment, specific examples of which are provided herein. The patient 106 may represent a particular patient in a given clinical setting, such as in a doctor's office, or in a hospital, who is to be diagnosed and/or treated using the diagnosis system 102. The patient 106 also may represent the more abstract notion of a class of patients (e.g., patients having a certain age, gender, race, genetic makeup, or disposition to illness or disease), or, even more generally, may represent the general notion of a generic patient during basic research and/or development or application of various medical treatments or procedures. In the latter sense, the patient 106 also may represent a non-human animal (such as a primate) believed to be sufficiently similar to a human for the particular purposes that they may usefully substitute for such for the particular purposes.

In the example of FIG. 1, the diagnosis system 102 may be used to provide a user interface 108 that may represent, for example, a browser or virtually any type of interactive application that allows for receipt and display of text, graphics, video, or other types of information. As shown, the user interface 108 may be used to provide graphical representations of patient characteristics in the form of spider charts 110a, 110b, and 110c. In this context, spider charts, which also may be referred to as radar charts, star charts or other corresponding terminology, refer to graphical representations in which multiple variables are illustrated or expressed with respect to corresponding axes that are joined, e.g., at a center point. For example, the spider chart 110a illustrates axes “a”-“f” that are joined at a common or center point.

As described herein, the spider chart 110a and similar graphical representations, shown conceptually in FIG. 1 as spider chart 110b and spider chart 110c, may be used to represent patient characteristics in a manner that allows for fast, easy, and accurate diagnosis of the patient 106. For example, the clinician 104 may be assisted in determining that the patient 106 suffers from a particular illness or other ailment. As another example, the clinician 104 may be assisted in determining that the patient 106 is in more immediate need of medical assistance than another patient (e.g., in a triage setting). As yet another example, the clinician 104 may be assisted in evaluating a condition of the patient 106 over a period of time, e.g., in order to determine whether a condition of the patient 106 is improving or deteriorating.

In more specific examples, the spider chart 110a may include the axes a-f, which may represent, for example, various diagnosis parameters or other patient characteristics, such as past or present physical symptoms of the patient 106, a social or family history of the patient 106, current medications of the patient 106, or other parameters or characteristics that may be useful in diagnosing the patient 106, examples of which are provided herein. The axes a-f may each represent a single such parameter, or may represent a collection or synthesis of such parameters (such as, for example, when each axis represents a potential diagnosis, e.g., a potential illness, associated with the patient 106, where each individual diagnosis may be associated with multiple, different symptoms).

In the example of FIG. 1, the spider chart 110a thus includes a plot 111 that is defined by a plotting of the referenced diagnosis parameters, based on actual values for the diagnosis parameters associated with the patient 106. For example, when the spider chart 110a is used to plot physical symptoms such as a patients' temperature, blood pressure, heart rate, or other numerically-quantifiable symptoms, then values for these symptoms may be plotted on the spider chart 110a to form the plot 111.

Thus, the spider chart 110a represents a patient-specific spider chart that includes a patient-specific plot. As described herein, however, this is but one example of use for spider charts 110a, 110b, 110c, and associated plots. For example, the spider charts 110b, 110c may represent diagnosis-specific spider charts (and associated plots, not shown in FIG. 1). For example, a diagnosis of influenza may be associated with certain values of the symptoms mentioned above, and/or other symptoms. Consequently, a plot of these values on the spider chart 110b may provide a graphical or visual illustration of an influenza diagnosis. Then, the clinician 104 may visually compare such a plot to the patient-specific plot 111 to determine whether the two plots are sufficiently similar to warrant either a diagnosis of influenza or a further investigation of the possibility of influenza.

Similarly, the spider chart 110c may visually represent some other potential diagnosis, such as pneumonia. By visually comparing the patient-specific spider chart 110a with the potential diagnosis spider charts 110b, 110c, the clinician may quickly and easily determine which of the two diagnoses is more likely for the patient 106.

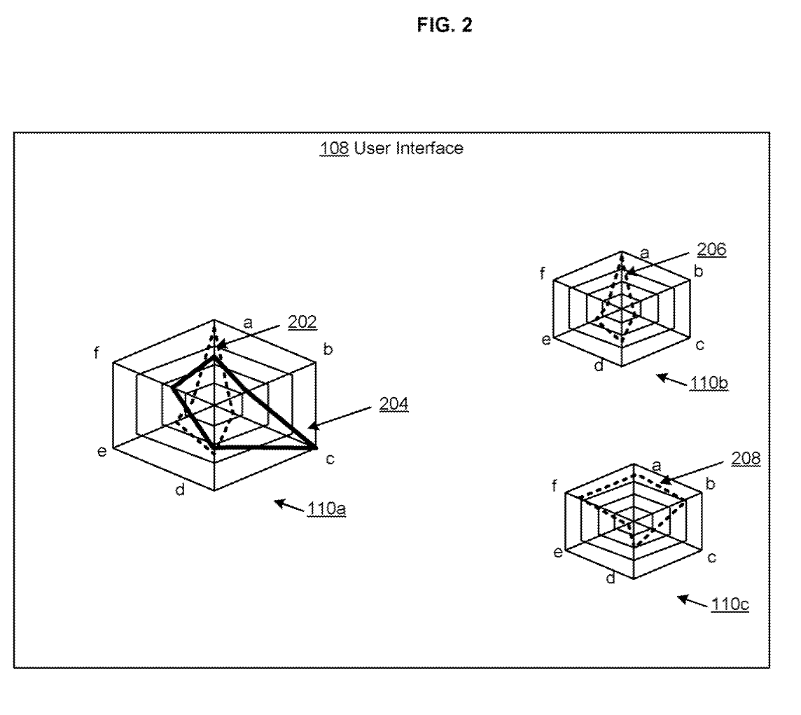

Further examples of the spider charts 110a, 110b, 110 c (and associated plots) are provided herein, e.g., with respect to FIG. 2. In general, however, it will be appreciated that the spider charts 110a, 110b, 110c provide the clinician 104 with a straight-forward and intuitive technique(s) for diagnosing the patient 106.

In order to provide the spider charts 110a, 110b, 110c, the diagnosis system 102 may receive at least one set of diagnosis parameters associated with one or more patients, such as the patient 106. As shown in FIG. 1, for example, the user interface 108 may include one or more input fields 112, with which the clinician 104, the patient 106, or some other user, not shown, may enter diagnosis parameters relevant to the patient 106.

For example, the clinician 104 may interview the patient 106 to obtain diagnosis parameters that may then be entered into the input fields 112. As another example, the patient 106 may be given the opportunity to enter self-perceived diagnosis parameters. The input fields 112 may provide for receipt of the diagnosis parameters using, e.g., drop-down menus, text boxes, multiple-choice question/answer pairs or other types of question/answer pairs, or virtually any technique for inputting data into the user interface 108.

In more specific examples, the input fields 112 may be associated with a graphical representation (e.g., a bodily representation) of the patient 106 (or a generic patient), so that the clinician 104, patient 106, or other user, may designate portions of the graphically-represented body to indicate symptoms or other ailments associated therewith. In other examples, the input fields 112 may be associated with a generic spider chart, which the clinician 104, the patient 106, or other user may then manipulate to enter the diagnosis parameters. For example, the spider chart 110a may initially be presented as a blank spider chart having identified axes, and the clinician 104, the patient 106, or other user may input the plot 111 simply by appropriate selection of one or more axes of the spider chart 110a. In this example, for example, if the spider chart 110a associates the axis “a” with temperature and is marked from 90 degrees Fahrenheit to 110 degrees Fahrenheit, then the clinician 104, patient 106, or other user may simply click on (or otherwise select) a current patient temperature (such as 102 degrees Fahrenheit) to provide a point on that axis for the plot 111.

Other aspects of the user interface 108 also may be used advantageously. For example, once the clinician 104 determines a potential diagnosis based on a visual comparison of the spider charts 110a, 110b, 110c and associated plots, then the user interface 108 may be used to provide treatment options 114 for the determined diagnosis. For example, the treatment options 114 may include potential medications, procedures, or other curative or palliative treatments for the patient 106. The treatment options 114 may be presented using text, visual, audio/video, or virtually any compatible technique for presenting information with the user interface 108.

The diagnosis system 102 may include, for example, one or more modules, agents, or other software-based applications that may be configured to provide the functionality described herein, and/or related functionality. For example, in FIG. 1, the diagnosis system 102 is illustrated as including a parameter handler 116 that may be configured to receive the one or more diagnosis parameters, e.g., from the input fields 112.

In other examples, sensors 117 may be used to collect or otherwise determine the diagnosis parameters, in conjunction with the parameter handler 116. For example, the sensors 117 may include heart rate monitors, blood-pressure monitors, or virtually any other diagnosis parameter that may be detected electro-mechanically.

Using the received diagnosis parameters, a spider chart generator 118 may be configured to determine one or more spider charts associated with one or more potential diagnoses for the one or more patients. For example, for the spider chart 110a, the spider chart generator 118 may create the appropriate axes associated with the received diagnosis parameters, and may plot the received values for the diagnosis parameters accordingly. In so doing, for example, the spider chart generator 118 may normalize or otherwise process the received values, in order to plot otherwise disparate numerical values relative to one another.

In generating the one or more spider charts, the spider chart generator 118 may access or otherwise utilize a graphical representation database 120. The graphical representation database 120 may include, for example, a database or other type of memory that stores whole or partial templates (or other relevant information) for use in generating the spider charts. For example, in some situations the parameter handler 116 may receive a number of diagnosis parameters, which may be associated with, as described herein, characteristics of the patient 106 such as physical symptoms, family/social history, current medications, current laboratory results, or other relevant characteristics or parameters. These parameters may or may not be capable of representation on a single spider chart in a meaningful fashion, so that the spider chart generator 118 may be configured to separate the received parameters for appropriate plotting on corresponding spider charts, and, in so doing, may access the graphical representations database 120 to determine possible axes for constructing possible spider charts. More generally, and as described in more detail herein, the spider chart generator 118 may access the graphical representations database 120 in order to determine any useful information in generating a spider chart that corresponds to received diagnosis parameters and/or that corresponds to potential diagnosis.

For example, a diagnosis generator 122 may be configured to receive the diagnosis parameters and to access a diagnosis database 124 to thereby generate a number of potential diagnoses. In the example mentioned above, the diagnosis generator 122 may receive the diagnosis parameters and may execute one or more algorithms to determine potential diagnoses of influenza or pneumonia. Although examples of such diagnosis algorithms are known (e.g., implementing one or more of an expert system, an interactive wizard, a knowledge-based system, a neural network, a weighted matching of patient symptoms to corresponding ailments, or virtually any algorithmic technique for determining a diagnosis based on one or more parameters), it may be appreciated that outputs of the diagnosis generator 122 may be insufficient to completely or accurately diagnose a particular illness or other ailment of the patient 106, particularly for less-experienced clinicians 104 or for situations in which the clinician 104 is time-limited. In the system of FIG. 1, the diagnosis generator 122 may thus be used to generate a plurality of most-likely possible diagnoses, each of which may then be represented as a spider chart by the spider chart generator 118 (and the graphical representations database 120), e.g., as the spider charts 110b, 110c.

A view generator 126 may then be used to provide the one or more spider charts in visual proximity to one another, e.g., on the user interface 108. By placing the one or more spider charts in visual proximity to one another, the clinician 104 or other user may quickly and easily perform a visual comparison between the one or more spider charts. Although the example of FIG. 1 illustrates an example in which three spider charts 110a, 110b, 110c are displayed next to one another, it may be appreciated that many other techniques exist for providing the one or more spider charts in visual proximity to one another. For example, a single set of axes (e.g., “a”-“f”) may be provided, and multiple plots may be presented thereon (e.g., corresponding to multiple patients or to a single patient and several possible diagnoses, as described herein, where different patients/diagnoses may be visually differentiated by color, highlighting, or other visual indicator(s)).

Also in FIG. 1, the diagnosis system 102 is illustrated as possibly being included within a device 128. The device 128 may include, for example, a mobile computing device, such as a personal digital assistant (PDA), or a laptop computer. Of course, virtually any other computing device may be used to implement the diagnosis system 102, such as, for example, a workstation, a desktop computer, or a tablet PC. Of course, in practice, not all of the diagnosis system 102 need be implemented on a single computing device. For example, the parameter handler 116 and the view generator 126 may be implemented in part on a first device that is used locally by the clinician 104, while one or more of the spider chart generator 118, the diagnosis generator 122, the graphical representations database 120, and the diagnosis database 124 may be stored and/or executed on a remote, networked device(s). In this way, the clinician 104, who may be operating in the field, e.g., in an office and/or hospital environment, may be relieved of a responsibility to update, manage, or manipulate the contents of the database(s) 120, 124, or other otherwise modify or update the diagnosis system 102, and may focus on determining accurate diagnoses for the patient 106.

FIG. 2 illustrates examples of the graphical representations of FIG. 1 in which the graphical representations include one or more spider charts. As shown in FIG. 2, the user interface 108 may provide the first spider chart 110a as including a first plot 202 and a second plot 204. The user interface 108 may further provide the spider chart 110b having a plot 206, and the spider chart 110c having a plot 208.

In one example, then, the plots 202 and 204 may be patient-specific, e.g., may correspond to the patient 106 and to another patient. Consequently, the patients may be judged relative to one another with respect to their relative need for medical attention. For example, the clinician 104 may evaluate patients in a triage setting, such as in an emergency room. If the axis “c” corresponds to a patient temperature, then the clinician 104 may immediately notice that a temperature of the patient corresponding to the plot 204 is significantly higher than that of the patient corresponding to the plot 202, and may react accordingly. In other examples, the plots 202, 204 may correspond to the single patient 106, e.g., over a period of time, so that the clinician 104 may quickly observe that the temperature of the patient 106 is rising over the relevant time frame.

In these and other examples, the spider charts 110b, 110c may represent possible diagnoses for the patient(s) of the spider chart 110a. For example, the spider charts 110b, 110c may share identical axes with each other and with the spider chart 110a, and may have, respectively, the plot 206 corresponding to a first diagnosis (e.g., influenza) and the plot 208 corresponding to a second diagnosis (e.g., pneumonia). Then, the clinician 104 may compare the plots 202, 204, 206 to determine that the patient corresponding to the plot 202 may suffer from influenza, based on the relative similarity of the plots 202, 206 (and the relative lack of similarity between the plots 202, 208). Meanwhile, if the plot 204 corresponds to another patient, then the clinician may determine that this other patient seems unlikely to suffer from either potential diagnosis, and may act accordingly (e.g., may collect/select more and/or different diagnosis parameters).

It will be appreciated that FIG. 2 is not intended to provide a complete, detailed, or comprehensive set of examples of how the diagnosis system 102 may determine or provide one or more spider charts. Rather, FIG. 2 merely provides a small number of selected examples, and additional and/or alternative examples are provided herein, as well. Further examples of implementation and use of the diagnosis system 102, the user interface 108, and related techniques, also may be apparent.

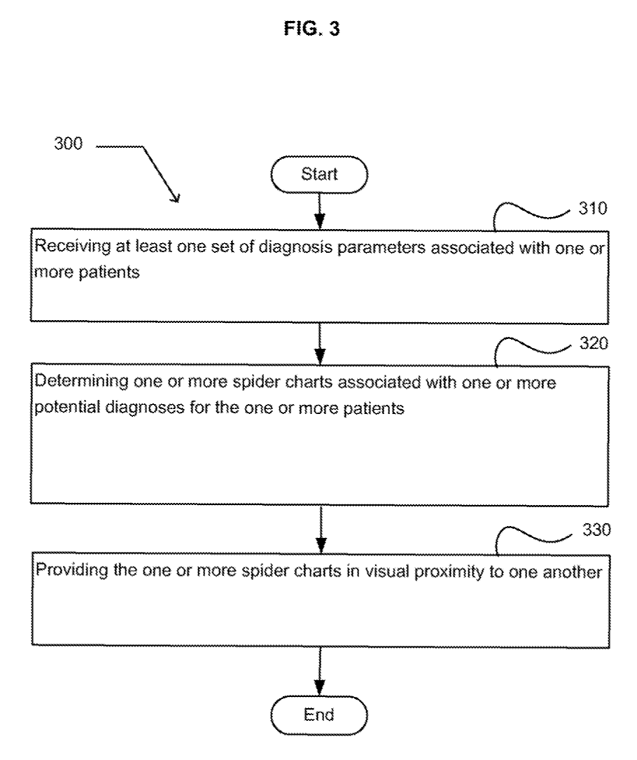

FIG. 3 illustrates an operational flow representing example operations related to diagnosis through graphical representations of patient characteristics. In FIG. 3 and in following figures that include various examples of operational flows, discussion and explanation may be provided with respect to the above-described examples of FIGS. 1 and 2, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 300 moves to a receiving operation 310, where at least one set of diagnosis parameters associated with one or more patients may be received. For example, the parameter handler 116 may receive one or more diagnosis parameters (e.g., symptoms, complaints, medical history, or other diagnosis-related information) associated with the patient 106, either by way of the input fields 112 of the user interface 108, and/or by way of the sensors 117.

In a determining operation 320, one or more spider charts associated with one or more potential diagnoses for the one or more patients may be determined. For example, the spider chart generator 118 may determine the spider charts 110a, 110b, 110c. As described, the spider charts 110a, 110b, 110c may be associated with the patient 106 and possibly other patients, and/or may be associated with a potential diagnosis for one or more of the patient(s). As described herein, for example, one or more spider charts may be associated with a single patient and/or diagnosis, or a single spider chart may be associated with multiple patients and/or multiple diagnoses, or multiple spider charts may be associated with multiple patients and/or multiple diagnoses. Examples of these various scenarios, and other scenarios, are provided in more detail, herein.

In a providing operation 330, the one or more spider charts may be provided in visual proximity to one another. For example, the view generator 126 may be configured to provide the spider charts 110a, 110b, 110c in visual proximity to one another within the user interface 108. In various examples, the spider charts 110a, 110b, 110c may be provided next to one another or superimposed on one another, or may be movable (e.g., dragged-and-dropped) within the user interface 108. More details regarding these and other examples are provided herein.

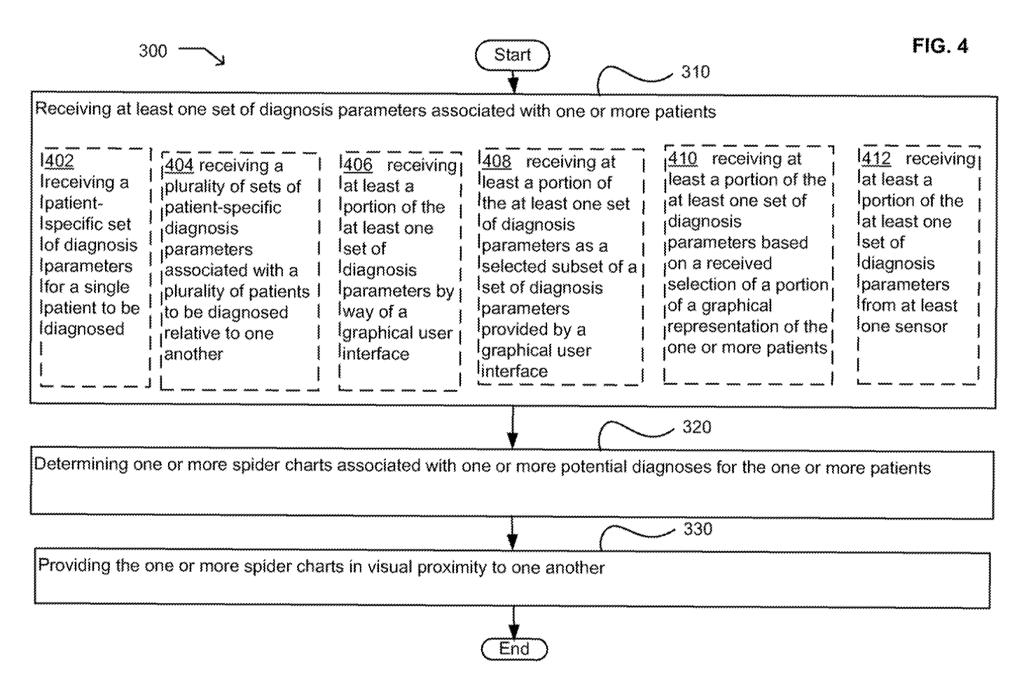

FIG. 4 illustrates alternative embodiments of the example operational flow 300 of FIG. 3. FIG. 4 illustrates example embodiments where the receiving operation 310 may include at least one additional operation. Additional operations may include an operation 402, an operation 404, an operation 406, an operation 408, and operation 410, and/or an operation 412.

At the operation 402 a patient-specific set of diagnosis parameters may be received for a single patient to be diagnosed. For example, the parameter handler 116 may receive a set of diagnosis parameters specific to the patient 106, e.g., through the input fields 112 of the user interface 108, or through the sensor(s) 117.

At the operation 404, a plurality of sets of patient-specific diagnosis parameters may be received that are associated with a plurality of patients to be diagnosed relative to one another. For example, the parameter handler 116 may be configured to receive such a plurality of sets of diagnosis parameters, e.g., by way of the input fields 112, for a plurality of patients to be triaged, e.g., in an emergency room. By comparing spider chart(s) associated with each of the patients (or by comparing patient-specific plots on a single spider chart), the clinician 104 may determine which of the plurality of patients is most in need of medical attention, and may react accordingly.

At the operation 406, at least a portion of the at least one set of diagnosis parameters may be received by way of a graphical user interface. For example, the parameter handler 116 may be configured to receive the at least one set of diagnosis parameters by way of the user interface 108, e.g., using the input fields 112.

At the operation 408, at least a portion of the at least one set of diagnosis parameters may be received as a selected subset of a set of diagnosis parameters provided by a graphical user interface. For example, the parameter handler 116 may be configured to receive the set of diagnosis parameters by way of the input fields 112, such as may be input by the patient 106 or by a first-responder attempting to input a comprehensive set of diagnosis parameters. Then, the clinician 104 (e.g., a physician) may use the input fields 112 to select a subset of the set of diagnosis parameters, e.g., a subset considered by the clinician 104 to be most relevant or most helpful in diagnosing the patient 106.

At the operation 410, at least a portion of the at least one set of diagnosis parameters may be received based on a received selection of a portion of a graphical representation of the one or more patients. For example, the parameter handler 116, perhaps in conjunction with the view generator 126, may generate a body-shaped graphic for display on the user interface 108, where the body-shaped graphic represents the patient 106 and allows for selection of various portions of the body-shaped graphic for designation of symptoms or other diagnosis parameters with respect thereto.

At the operation 412, at least a portion of the at least one set of diagnosis parameters may be received from at least one sensor. For example, the parameter handler 116 may be configured to receive one or more diagnosis parameters from the sensor 117, e.g., a heart rate monitor or other type of monitoring or sensing device.

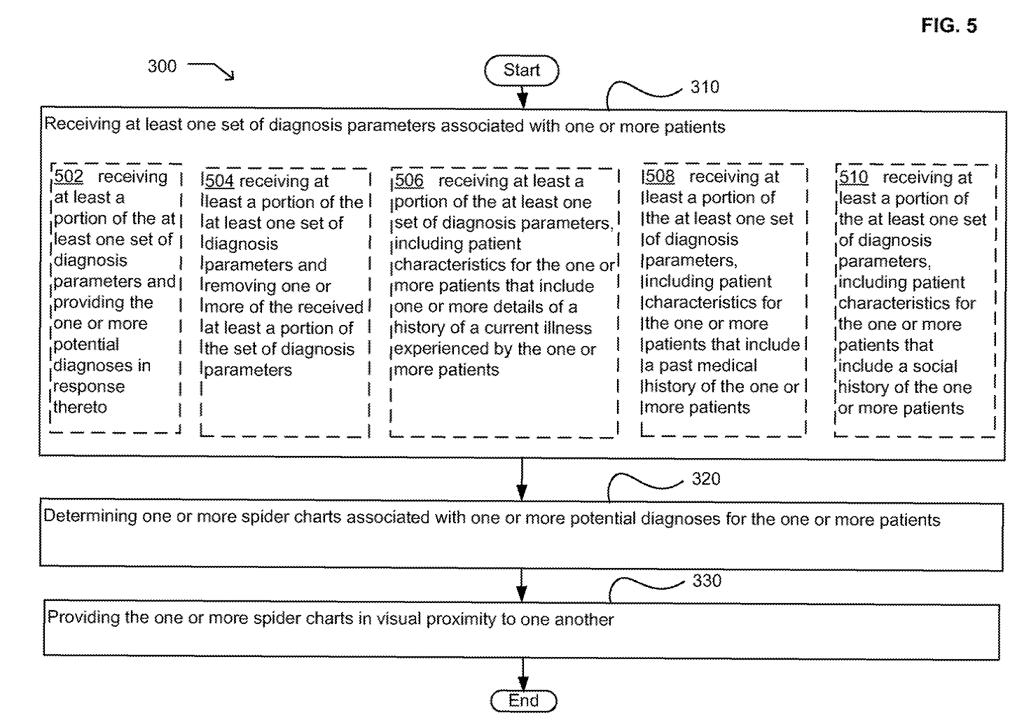

FIG. 5 illustrates alternative embodiments of the example operational flow 300 of FIG. 3. FIG. 5 illustrates example embodiments where the receiving operation 310 may include at least one additional operation. Additional operations may include an operation 502, an operation 504, an operation 506, an operation 508, and/or an operation 510.

At the operation 502, at least a portion of the at least one set of diagnosis parameters may be received and the one or more potential diagnoses may be provided in response thereto. For example, the parameter handler 116 may be configured to receive the diagnosis parameters by way of the input fields 112, and the diagnosis generator 122 and/or the spider chart generator 118 may be used to provide the potential diagnoses in response thereto.

At the operation 504, at least a portion of the at least one set of diagnosis parameters may be received and one or more of the received at least a portion of the set of diagnosis parameters may be removed. For example, the parameter handler 116 may be configured to receive the set of diagnosis parameters by way of the input fields 112. Then, the spider chart generator 118 and/or the diagnosis generator 122 may determine that one or more of the receive diagnosis parameters may not be useful in performing the desired diagnosis. Consequently, such diagnosis parameters may be excluded, ignored, or otherwise removed or not used by the spider chart generator 118 and/or the diagnosis generator 122 when determining the potential diagnosis. For example, it may be determined that an ethnicity of the patient 106 is not sufficiently relevant to a potential diagnosis or influenza or pneumonia.

At the operation 506, at least a portion of the at least one set of diagnosis parameters may be received, including patient characteristics for the one or more patients that include one or more details of a history of a current illness experienced by the one or more patients. For example, the parameter handler 116 may be configured to receive diagnosis parameters related to how long the patient 106 has experienced certain symptoms, or whether the symptoms have gotten worse or improved over time.

At the operation 508, at least a portion of the at least one set of diagnosis parameters may be received, including patient characteristics for the one or more patients that include a past medical history of the one or more patients. For example, the parameter handler 116 may be configured to receive diagnosis parameters related to whether the patient has underdone surgeries or other procedures.

At the operation 510, at least a portion of the at least one set of diagnosis parameters may be received, including patient characteristics for the one or more patients that include a social history of the one or more patients. For example, the parameter handler 116 may be configured to receive diagnosis parameters related to whether the patient 106 has visited certain countries, or has otherwise been in settings that may be conducive to suffering certain ailments.

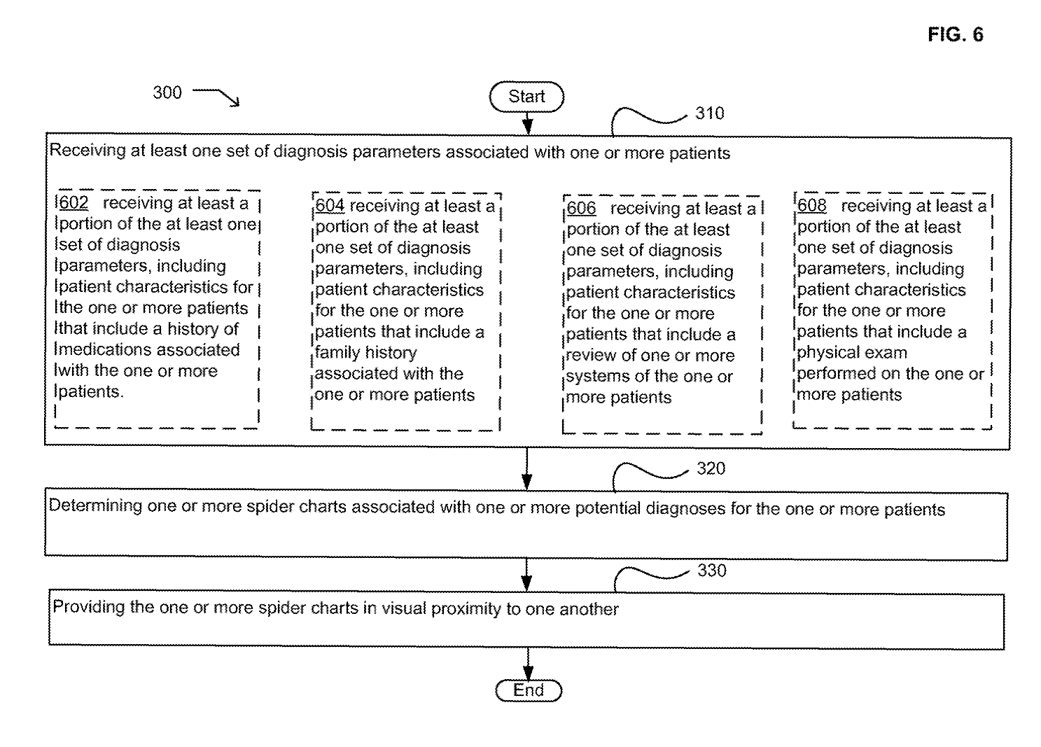

FIG. 6 illustrates alternative embodiments of the example operational flow 300 of FIG. 3. FIG. 6 illustrates example embodiments where the receiving operation 310 may include at least one additional operation. Additional operations may include an operation 602, an operation 604, an operation 606, and/or an operation 608.

At the operation 602, at least a portion of the at least one set of diagnosis parameters may be received, including patient characteristics for the one or more patients that include a history of medications associated with the one or more patients. For example, the parameter handler 116 may be configured to receive, e.g., by way of the input fields 112, diagnosis parameters related to whether the patient 106 is currently taking insulin for diabetes, or whether the patient 106 has a history of taking certain antibiotics.

At the operation 604, at least a portion of the at least one set of diagnosis parameters may be received, including patient characteristics for the one or more patients that include a family history associated with the one or more patients. For example, the parameter handler 116 may be configured to receive, e.g., by way of the input fields 112, diagnosis parameters related to whether heart disease runs in a family of the patient 106.

At the operation 606, at least a portion of the at least one set of diagnosis parameters may be received, including patient characteristics for the one or more patients that include a review of one or more systems of the one or more patients. For example, the parameter handler 116 may be configured to receive, e.g., by way of the input fields 112, diagnosis parameters related to a circulatory or respiratory system of the patient 106.

At the operation 608, at least a portion of the at least one set of diagnosis parameters may be received, including patient characteristics for the one or more patients that include a physical exam performed on the one or more patients. For example, the parameter handler 116 may be configured to receive, e.g., by way of the input fields 112, diagnosis parameters related to measurements that may be taken by the clinician 104 in examining the patient 106, e.g., a heart rate or temperature of the patient 106.

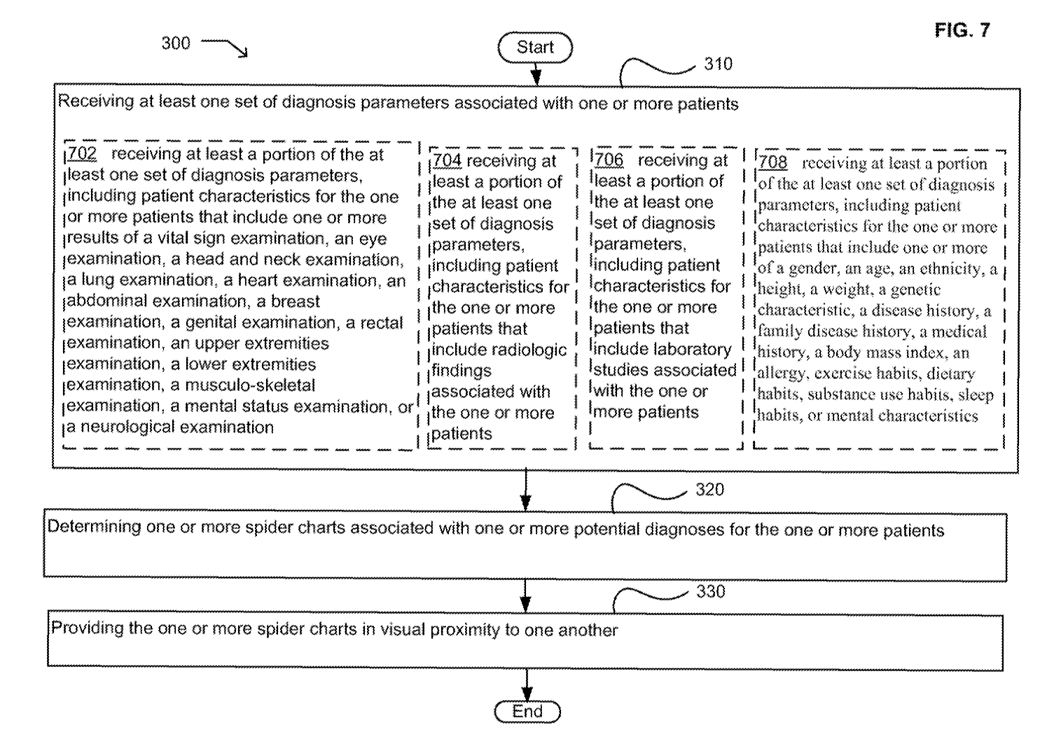

FIG. 7 illustrates alternative embodiments of the example operational flow 300 of FIG. 3. FIG. 7 illustrates example embodiments where the receiving operation 310 may include at least one additional operation. Additional operations may include an operation 702, an operation 704, an operation 706, and/or an operation 708.

At the operation 702, at least a portion of the at least one set of diagnosis parameters may be received, including patient characteristics for the one or more patients that include one or more results of a vital sign examination, an eye examination, a head and neck examination, a lung examination, a heart examination, an abdominal examination, a breast examination, a genital examination, a rectal examination, an upper extremities examination, a lower extremities examination, a musculo-skeletal examination, a mental status examination, or a neurological examination. For example, the parameter handler 116 may be configured to receive, e.g., by way of the input fields 112, results from one or more of the referenced examinations.

At the operation 704, at least a portion of the at least one set of diagnosis parameters may be received, including patient characteristics for the one or more patients that include radiologic findings associated with the one or more patients. For example, the parameter handler 116 may be configured to receive, e.g., by way of the input fields 112, results of an MRI test associated with the patient 106.

At the operation 706, at least a portion of the at least one set of diagnosis parameters may be received, including patient characteristics for the one or more patients that include laboratory studies associated with the one or more patients. For example, the parameter handler 116 may be configured to receive, e.g., by way of the input fields 112, results of a blood culture performed for the patient 106.

At the operation 708, at least a portion of the at least one set of diagnosis parameters may be received, including patient characteristics for the one or more patients that include one or more of a gender, an age, an ethnicity, a height, a weight, a genetic characteristic, a disease history, a family disease history, a medical history, a body mass index, an allergy, exercise habits, dietary habits, substance use habits, sleep habits, or mental characteristics. For example, the parameter handler 116 may be configured to receive, e.g., by way of the input fields 112, one or more of the referenced diagnosis parameters, as well as additional or alternative diagnosis parameters, e.g., diagnosis parameters related to substance use (e.g., tobacco, alcohol, or drugs), mental characteristics (e.g., depression, happiness, sadness, loneliness, fear), or other such relevant diagnosis parameters.

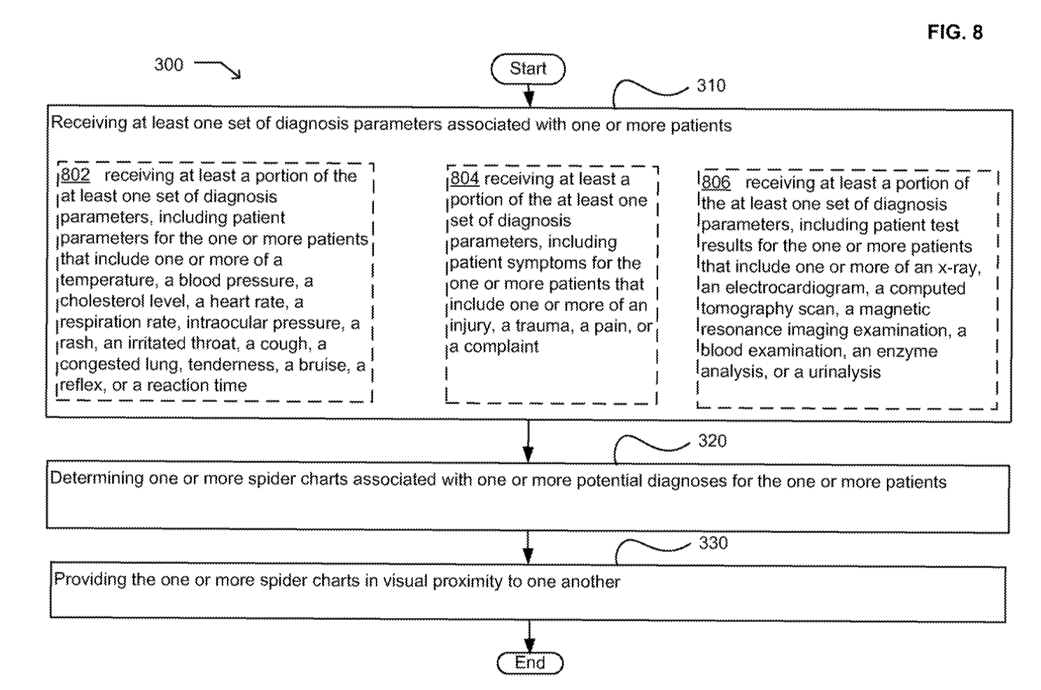

FIG. 8 illustrates alternative embodiments of the example operational flow 300 of FIG. 3. FIG. 8 illustrates example embodiments where the receiving operation 310 may include at least one additional operation. Additional operations may include an operation 802, an operation 804, and/or an operation 81

At the operation 802, at least a portion of the at least one set of diagnosis parameters may be received, including patient parameters for the one or more patients that include one or more of a temperature, a blood pressure, a cholesterol level, a heart rate, a respiration rate, intraocular pressure, a rash, an irritated throat, a cough, a congested lung, tenderness, a bruise, a reflex, or a reaction time. For example, the parameter handler 116 may be configured to receive, e.g., by way of the input fields 112, information regarding one or more of the referenced diagnosis parameters (e.g., an indicator for a cough, along with information regarding a severity and duration of the cough).

At the operation 804, at least a portion of the at least one set of diagnosis parameters may be received, including patient symptoms for the one or more patients that include one or more of an injury, a trauma, a pain, or a complaint. For example, the parameter handler 116 may be configured to receive, e.g., by way of the input fields 112, an injury trauma or complaint presented by the patient 106.

At the operation 806, at least a portion of the at least one set of diagnosis parameters may be received, including patient test results for the one or more patients that include one or more of an x-ray, an electrocardiogram, a computed tomography scan, a magnetic resonance imaging examination, a blood examination, an enzyme analysis, or a urinalysis. For example, the parameter handler 116 may be configured to receive, e.g., by way of the input fields 112, quantitative values associated with a performance of one or more of the referenced tests, and/or other tests, not specifically mentioned here.

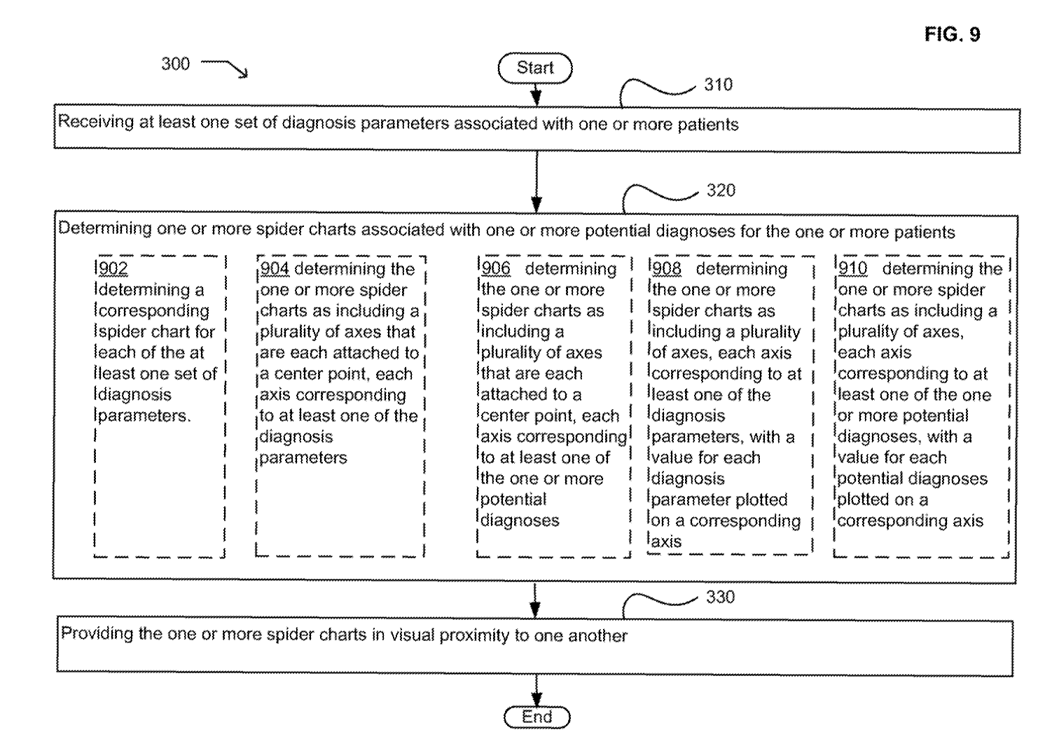

FIG. 9 illustrates alternative embodiments of the example operational flow 300 of FIG. 3. FIG. 9 illustrates example embodiments where the determining operation 320 may include at least one additional operation. Additional operations may include an operation 902, an operation 904, an operation 906, an operation 908, and/or an operation 910.

At the operation 902, a corresponding spider chart may be determined for each of the at least one set of diagnosis parameters. For example, the spider chart generator 118 may be configured to input the at least one set of diagnosis parameters and determine, e.g., using the graphical representations database 120, a corresponding spider chart, such as the spider chart 110a. For example, if the spider chart generator 118 receives 20 or more diagnosis parameters for the patient 106, then the spider chart generator 118 may be configured to determine sub-groups of these diagnosis parameters that may be relevant to one another (e.g., that include laboratory findings, or that include physical symptoms). For example, the spider chart generator 118 may match the received diagnosis parameters against spider chart templates in the graphical representations database 120 to determine a form of the one or more spider charts. In other examples, the spider chart generator 118 may be configured to generate a spider chart for all received diagnosis parameters

At the operation 904, the one or more spider charts may be determined as including a plurality of axes that are each attached to a center point, each axis corresponding to at least one of the diagnosis parameters. For example, the spider chart generator 118 may be configured to generate the spider chart 110a as including the axes “a”-“f,” as shown in the example of FIG. 1, which each axis “a”-“f” may correspond to one or more diagnosis parameter(s).

At the operation 906, the one or more spider charts may be determined as including a plurality of axes that are each attached to a center point, each axis corresponding to at least one of the one or more potential diagnoses. For example, the spider chart generator 118 may be configured to generate the spider chart 110a as including the axes “a”-“f,” where each axis is associated with a potential diagnosis, such as influenza, pneumonia, or the common cold. Then, the clinician 104 or the patient 106 may have an initial idea of which diagnosis is mostly likely simply by observing which axis has the highest-plotted value for its corresponding diagnosis.

At the operation 908, the one or more spider charts may be determined as including a plurality of axes, each axis corresponding to at least one of the diagnosis parameters, with a value for each diagnosis parameter plotted on a corresponding axis. For example, the spider chart generator 118 may be configured to generate the spider chart 110a having the axes “a”-“f,” each including a numerical range along which a value for a corresponding diagnosis parameter may be plotted, so that the plot 111 may be formed accordingly.

At the operation 910, the one or more spider charts may be determined as including a plurality of axes, each axis corresponding to at least one of the one or more potential diagnoses, with a value for each potential diagnoses plotted on a corresponding axis. For example, the spider chart generator 118 may be configured to generate the spider chart 110a having the axes “a”-“f,” each including a numerical range along which a value for a corresponding potential diagnosis may be plotted, so that the plot 111 may be formed accordingly.

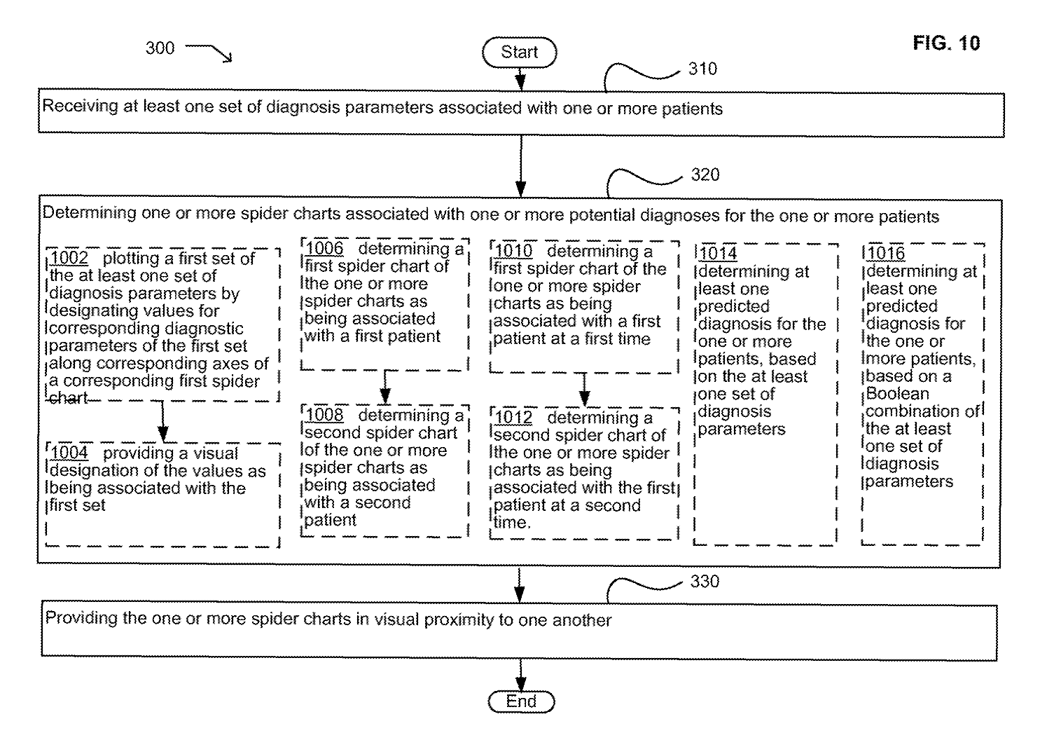

FIG. 10 illustrates alternative embodiments of the example operational flow 300 of FIG. 3. FIG. 10 illustrates example embodiments where the determining operation 320 may include at least one additional operation. Additional operations may include an operation 1002, an operation 1004, an operation 1006, an operation 1008, an operation 1110, an operation 1012, an operation 1014, and/or an operation 1016.

At the operation 1002, a first set of the at least one set of diagnosis parameters may be plotted by designating values for corresponding diagnostic parameters of the first set along corresponding axes of a corresponding first spider chart. For example, the spider chart generator 118 may be configured to generate the spider chart 110a having the axes “a”-“f,” each including a numerical range along which a value for a corresponding diagnosis parameter may be plotted, so that the plot 111 may be formed accordingly. At the operation 1004, a visual designation of the values as being associated with the first set may be provided. For example, the spider chart generator 118 may communicate to the view generator 126 that the plot 111 should have a specified visual indicator or designator (e.g., should be a specified color), so that, for example, a patient, a class of patients, or a diagnosis may be specified relative to other patients or diagnoses.

At the operation 1006, a first spider chart of the one or more spider charts may be determined as being associated with a first patient. For example, the spider chart generator 118 may determine that the spider chart 110a is to be associated with the patient 106. At the operation 1008, a second spider chart of the one or more spider charts may be determined as being associated with a second patient. For example, the spider chart generator 118 may determine that the spider chart 110b is to be associated with a second patient. In this way, as described herein, the first and second patient may easily be compared to one another, e.g., to determine their relative levels of need for medical attention, or otherwise to compare their symptoms, treatment, or recovery.

At an operation 1010, a first spider chart of the one or more spider charts may be determined as being associated with a first patient at a first time. For example, the spider chart generator 118 may determine that the spider chart 110a is to be associated with the patient 106 at a first time. At an operation 1012, a second spider chart of the one or more spider charts may be determined as being associated with the first patient at a second time. For example, the spider chart generator 118 may determine that the spider chart 110a is to be associated with the patient 106 at a second time. Thus, for example, the clinician 104 may observe a progress of the patient 106 over a period of time.

At an operation 1014, at least one predicted diagnosis for the one or more patients may be determined, based on the at least one set of diagnosis parameters. For example, the diagnosis generator 122 may receive the set of diagnosis parameters and may use one or more diagnosis algorithms, perhaps stored in the diagnosis database 124, to determine the predicted diagnosis.

At an operation 1016, at least one predicted diagnosis for the one or more patients may be determined, based on a Boolean combination of the at least one set of diagnosis parameters. For example, the diagnosis generator 122 may receive the set of diagnosis parameters and may use one or more diagnosis algorithms, perhaps stored in the diagnosis database 124, to perform different Boolean combinations using the diagnosis parameters to thereby determine the predicted diagnosis. For example, the diagnosis generator 122 may determine that “symptom X AND symptom Y AND (medication X OR medication Y)” is associated with a particular diagnosis.

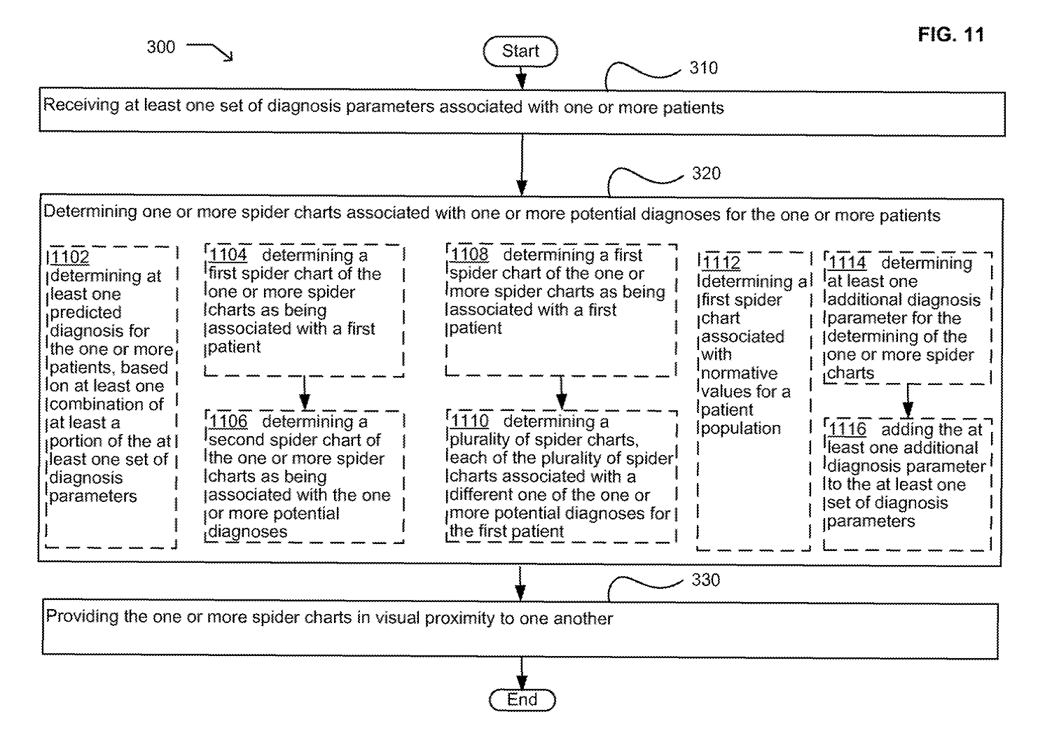

FIG. 11 illustrates alternative embodiments of the example operational flow 300 of FIG. 3. FIG. 11 illustrates example embodiments where the determining operation 320 may include at least one additional operation. Additional operations may include an operation 1102, an operation 1104, an operation 1106, an operation 1108, and operation 1110, an operation 1112, an operation 1114, and/or an operation 1116.

At the operation 1102, at least one predicted diagnosis for the one or more patients may be determined, based on at least one combination of at least a portion of the at least one set of diagnosis parameters. For example, the spider chart generator 118 may receive the parameter handler 116 some number of diagnosis parameters. Sub-groups of these diagnosis parameters may be grouped together and associated with a single axis of the spider chart 110a. Consequently, for example, the axis “a” may be associated with physical symptoms, while the axis “b” might be associated with a medication history.

At the operation 1104, a first spider chart of the one or more spider charts may be determined as being associated with a first patient. For example, the spider chart generator 118 may determine the spider chart 110a as being associated with the patient 106. At the operation 1106, a second spider chart of the one or more spider charts may be determined as being associated with the one or more potential diagnoses. For example, the spider chart generator 118 may determine the spider chart 110b as being associated with one or more potential diagnoses (e.g., influenza or pneumonia, as described herein). For example, multiple plots, each associated with a different potential diagnosis, may be formed, such as in the example of the plots 202 and 204 of FIG. 2.

At the operation 1108, a first spider chart of the one or more spider charts may be determined as being associated with a first patient. For example, the spider chart generator 118 may determine the spider chart 110a as being associated with the patient 106. At the operation 1110, a plurality of spider charts, each of the plurality of spider charts associated with a different one of the one or more potential diagnoses for the first patient, may be determined. For example, the spider chart generator 118 may determine the spider charts 110b, 110c as being associated with one or more potential diagnoses (e.g., influenza or pneumonia, as described herein).

At an operation 1112, a first spider chart associated with normative values for a patient population may be determined. For example, the spider chart generator 118 may access the graphical representation database and/or the diagnosis database 124 to determine normative values that may be relevant to the patient 106 and/or to a current diagnosis. For example, different sets of normative values may be determined for different ethnicities or for patients having particular social histories (e.g., drug use). The normative values may be plotted (e.g., as the plot 202 in FIG. 2) on a spider chart with a patient-specific plot (e.g., the plot 204 in FIG. 2).

At the operation 1114, at least one additional diagnosis parameter may be determined for the determining of the one or more spider charts. For example, the spider chart generator 118 may receive “n” diagnosis parameters from the parameter handler 116, and may access the graphical representation database 120 and/or the diagnosis database 124 to determine that an additional diagnosis parameter is needed, which may then be obtained, e.g., by requesting input thereof using the input fields 112. At the operation 1116, the at least one additional diagnosis parameter may be added to the at least one set of diagnosis parameters. For example, the spider chart generator 118 may then add the requested/received diagnosis parameter when determining the spider chart 110a. In these and other examples, then, the diagnosis system 102 may determine that a value for a particular diagnosis parameter, if known, may increase the chances of an accurate diagnosis, and may thus request a value for such a diagnostic parameter for use in providing the spider chart 110a.

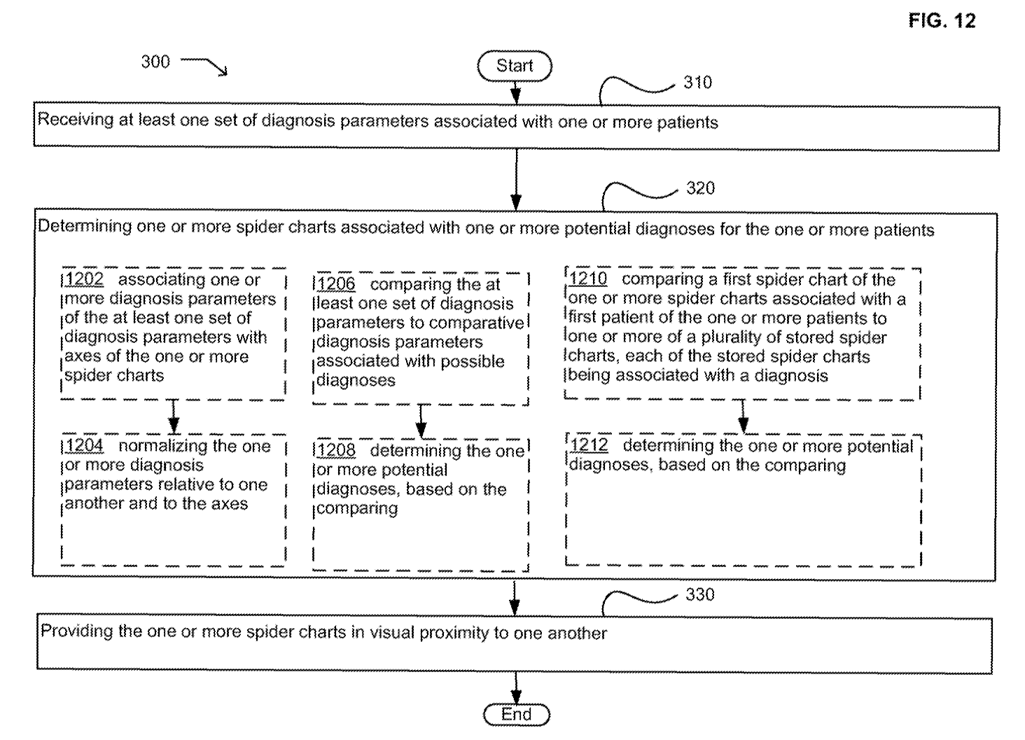

FIG. 12 illustrates alternative embodiments of the example operational flow 300 of FIG. 3. FIG. 12 illustrates example embodiments where the determining operation 320 may include at least one additional operation. Additional operations may include an operation 1202, an operation 1204, an operation 1206, an operation 1208, an operation 1210, and/or an operation 1212.

At the operation 1202, one or more diagnosis parameters of the at least one set of diagnosis parameters may be associated with axes of the one or more spider charts. For example, the spider chart generator 118 may generate the spider chart 110a having axes “a”-“f,” as described herein, with each such axis associated with a diagnosis. At the operation 1204, the one or more diagnosis parameters may be normalized relative to one another and to the axes. For example, symptoms may have varying normal ranges (e.g., heart rate, blood pressure, or temperature), and some symptoms may be viewed positively when relatively higher, whereas other symptoms may be viewed positively when relatively lower. Thus, the spider chart generator 118 may normalize values for these diagnosis parameters to a common scale associated with each axis of the generated spider charts.

At the operation 1206, the at least one set of diagnosis parameters may be compared to comparative diagnosis parameters associated with possible diagnoses. For example, the diagnosis generator 122 may be configured to compare received diagnosis parameters to comparative diagnosis parameters, which may be, e.g., stored in the diagnosis database 124. At the operation 1208, the one or more potential diagnoses may be determined, based on the comparing. For example, the diagnosis generator 122 may perform a statistical or probabilistic analysis of the received diagnosis parameters relative to the comparative diagnosis parameters, in order to determine the potential diagnosis.

At the operation 1210, a first spider chart of the one or more spider charts associated with a first patient of the one or more patients may be compared to one or more of a plurality of stored spider charts, each of the stored spider charts being associated with a diagnosis. For example, the diagnosis generator 122 may compare the spider chart 110a associated with the patient 106 with each of the spider charts 110b, 110c (associated with different diagnoses, which may be stored in the graphical representation database 120). At the operation 1212, the one or more potential diagnoses may be determined, based on the comparing. For example, the diagnosis generator 122 may perform automated pattern-matching between the spider chart 110a and the spider charts 110b, 110c to determine that the spider chart 110a more closely resembles the spider chart 110b, and may determine the potential diagnosis based on the matching.

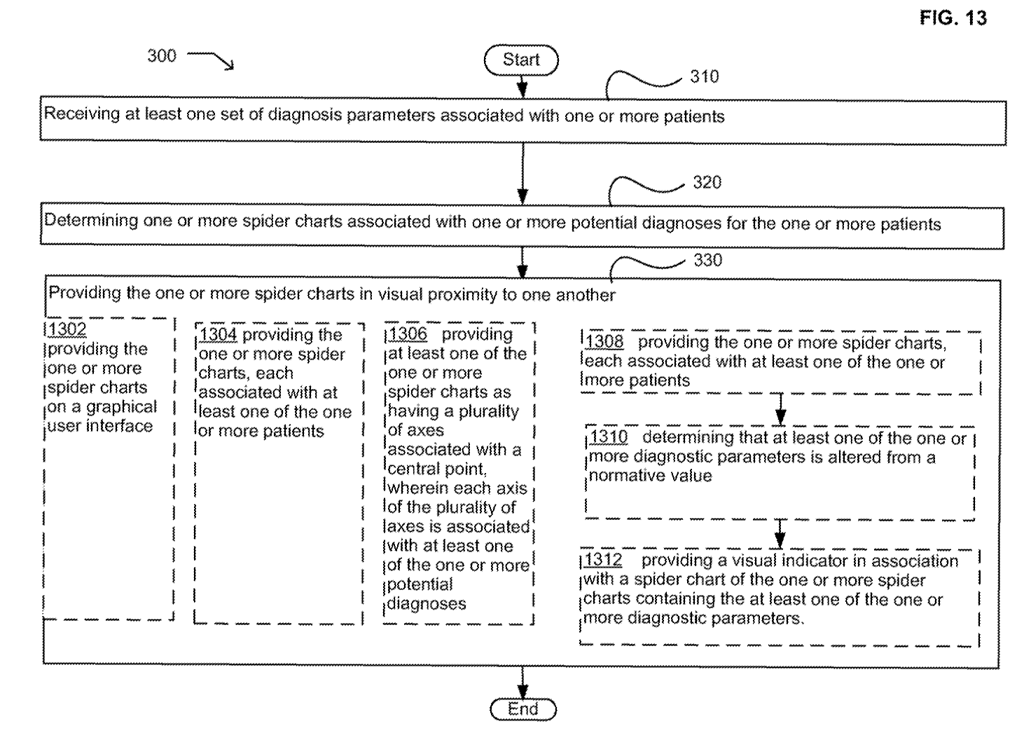

FIG. 13 illustrates alternative embodiments of the example operational flow 300 of FIG. 3. FIG. 13 illustrates example embodiments where the providing operation 330 may include at least one additional operation. Additional operations may include an operation 1302, an operation 1304, an operation 1306, an operation 1308, an operation 1310, and/or an operation 1312.

At the operation 1302, the one or more spider charts may be provided on a graphical user interface. For example, the view generator 126 may provide the spider charts 110a, 110b, 110c on the user interface 108.

At the operation 1304, the one or more spider charts may be provided, each associated with at least one of the one or more patients. For example, the view generator 126 may provide the spider chart 110a associated with the patient 106, and may provide each of the spider charts 110b, 110c in conjunction with another patient.

At the operation 1306, at least one of the one or more spider charts may be provided as having a plurality of axes associated with a central point, wherein each axis of the plurality of axes is associated with at least one of the one or more potential diagnoses. For example, the view generator 126 may be configured to generate the spider chart 110a as including the axes “a”-“f,” where each axis is associated with a potential diagnosis, such as influenza, pneumonia, or the common cold. Then, the clinician 104 or the patient 106 may have an initial idea of which diagnosis is mostly likely simply by observing which axis has the highest-plotted value for its corresponding diagnosis.

At the operation 1308, the one or more spider charts may be provided, each associated with at least one of the one or more patients. For example, the view generator 126 may provide the spider chart 110a associated with the patient 106, and may provide each of the spider charts 110b, 110c in conjunction with another patient. At the operation 1310, it may be determined that at least one of the one or more diagnostic parameters is altered from a normative value. For example, the spider chart generator 118 may determine that a particular diagnosis parameter have a value that is higher or lower than a corresponding normative value. At the operation 1312, a visual indicator may be provided in association with a spider chart of the one or more spider charts containing the at least one of the one or more diagnostic parameters. For example, the view generator 126 may visually alter a spider chart associated with a non-normative value when presenting a plurality of spider charts on the user interface 108.

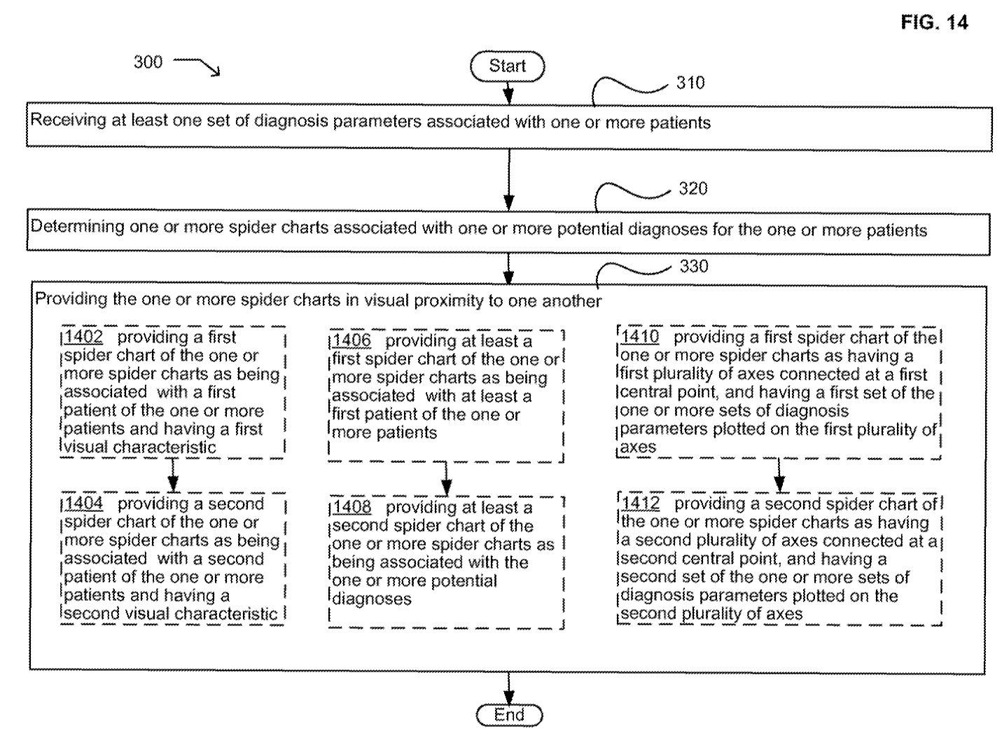

FIG. 14 illustrates alternative embodiments of the example operational flow 300 of FIG. 3. FIG. 14 illustrates example embodiments where the providing operation 330 may include at least one additional operation. Additional operations may include an operation 1402, an operation 1404, an operation 1406, an operation 1408, an operation 1410, and/or an operation 1412.

At the operation 1402, a first spider chart of the one or more spider charts may be provided as being associated with a first patient of the one or more patients and having a first visual characteristic. For example, the view generator 126 may provide the spider chart 110a as being associated with the patient 106 and having a first color (or other visual designation). At the operation 1404, a second spider chart of the one or more spider charts may be provided as being associated with a second patient of the one or more patients and having a second visual characteristic. For example, the view generator 126 may provide the spider chart 110b as being associated with another patient and having a second color (or other visual designation). In this way, the clinician 104 may quickly and easily distinguish between patients.

At the operation 1406, at least a first spider chart of the one or more spider charts may be provided as being associated with at least a first patient of the one or more patients. For example, the view generator 126 may provide the spider chart 110a as being associated with the patient 106 and having a first color (or other visual designation). At the operation 1408, at least a second spider chart of the one or more spider charts may be provided as being associated with the one or more potential diagnoses. For example, the view generator 126 may provide the spider chart 110b as being associated with one or more diagnoses, such as influenza or pneumonia.

At an operation 1410, a first spider chart of the one or more spider charts may be provided as having a first plurality of axes connected at a first central point, and having a first set of the one or more sets of diagnosis parameters plotted on the first plurality of axes. For example, the view generator 126 may be configured to generate the spider chart 110a as including the axes “a”-“f,” as shown in the example of FIG. 1, in which each axis “a”-“f” may correspond to one or more diagnosis parameter(s) and may have a first set of the diagnosis parameters plotted thereon. At an operation 1412, a second spider chart of the one or more spider charts may be provided as having a second plurality of axes connected at a second central point, and having a second set of the one or more sets of diagnosis parameters plotted on the second plurality of axes. For example, the view generator 126 may be configured to generate the spider chart 110b as including the axes “a”-“f,” as shown in the example of FIG. 1, in which each axis “a”-“f” may correspond to one or more diagnosis parameter(s) and may have a second set of the diagnosis parameters plotted thereon. In this way, as described, different spider charts may be associated with different patients and/or different diagnoses.

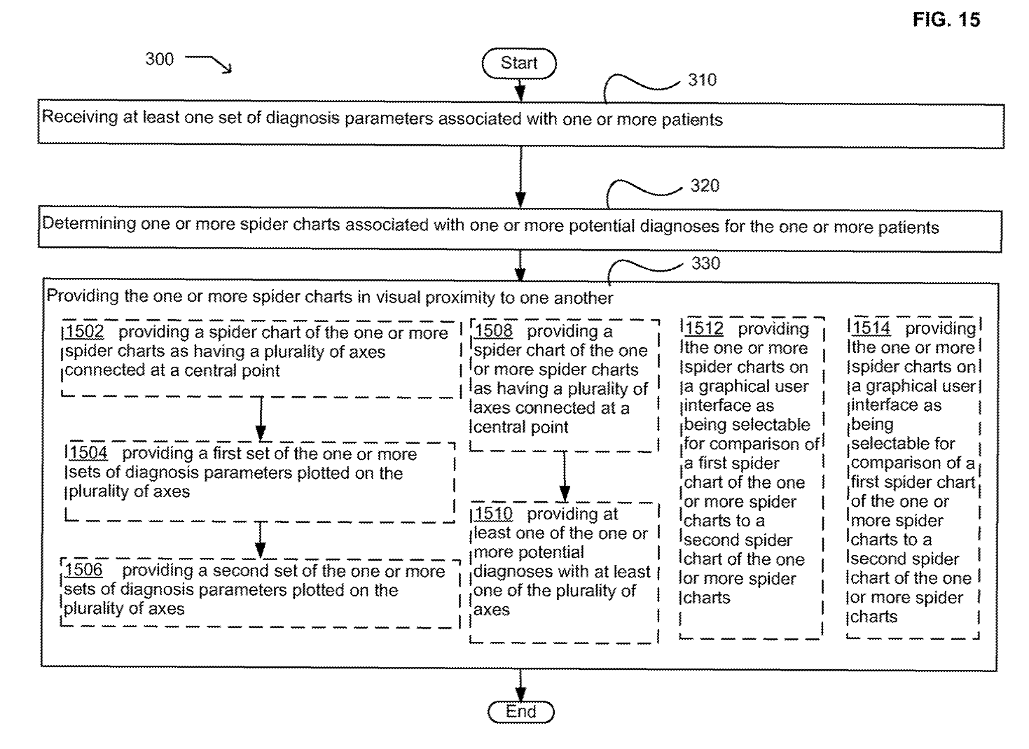

FIG. 15 illustrates alternative embodiments of the example operational flow 300 of FIG. 3. FIG. 15 illustrates example embodiments where the providing operation 330 may include at least one additional operation. Additional operations may include an operation 1502, an operation 1504, an operation 1506, an operation 1508, an operation 1510, an operation 1512, and/or an operation 1514.

At an operation 1502, a spider chart of the one or more spider charts may be provided as having a plurality of axes connected at a central point. For example, the view generator 126 may be configured to generate the spider chart 110a as including the axes “a”-“f,” as shown in the example of FIG. 1. At the operation 1504, a first set of the one or more sets of diagnosis parameters may be provided by plotting on the plurality of axes. For example, the view generator 126 may provide the plot 202 on the axes “a” of the spider chart 110a, as shown in FIG. 2. At the operation 1506, a second set of the one or more sets of diagnosis parameters may be provided by plotting on the plurality of axes. For example, the view generator 126 may provide the plot 204 on the axes “a”-“f” of the spider chart 110a, as shown in FIG. 2.

At the operation 1508, a spider chart of the one or more spider charts may be provided as having a plurality of axes connected at a central point. For example, the view generator 126 may be configured to generate the spider chart 110a as including the axes “a”-“f,” as shown in the example of FIG. 1. At the operation 1510, at least one of the one or more potential diagnoses may be provided with at least one of the plurality of axes. For example, the view generator 126 may be configured to generate the spider chart 110a as including a potential diagnosis (e.g., influenza or pneumonia) with each of the axes “a”-“f.”

At the operation 1512, the one or more spider charts may be provided on a graphical user interface as being selectable for comparison of a first spider chart of the one or more spider charts to a second spider chart of the one or more spider charts. For example, the view generator 126 may provide the spider charts 110a, 110b, 110c on the user interface 108. The clinician 104 or other user may then easily compare the spider charts to perform a diagnosis, as described herein. In example implementations, the view generator 114 may provide the spider charts as movable within the user interface 108, so that, for example, the clinician 104 may “drag-and-drop” one of the spider charts for superimposing on another spider chart(s), to facilitate comparison therebetween.

At an operation 1514, in response to a selection of at least one of the one or more spider charts, refinement factors for refining the selected spider chart may be provided. For example, the view generator 126 and/or the parameter handler 116 may receive a selection of a spider chart corresponding to a potential diagnosis (e.g., influenza). Then, perhaps based on input from the diagnosis generator 122, the view generator 126 may provide additional queries for further diagnosis parameters that may be particularly relevant to the selected spider chart (diagnosis). Such refinement diagnosis parameters may then be accepted, e.g., by way of the input fields 112, so that the selected diagnosis may be, for example, either confirmed or eliminated as a correct diagnosis.

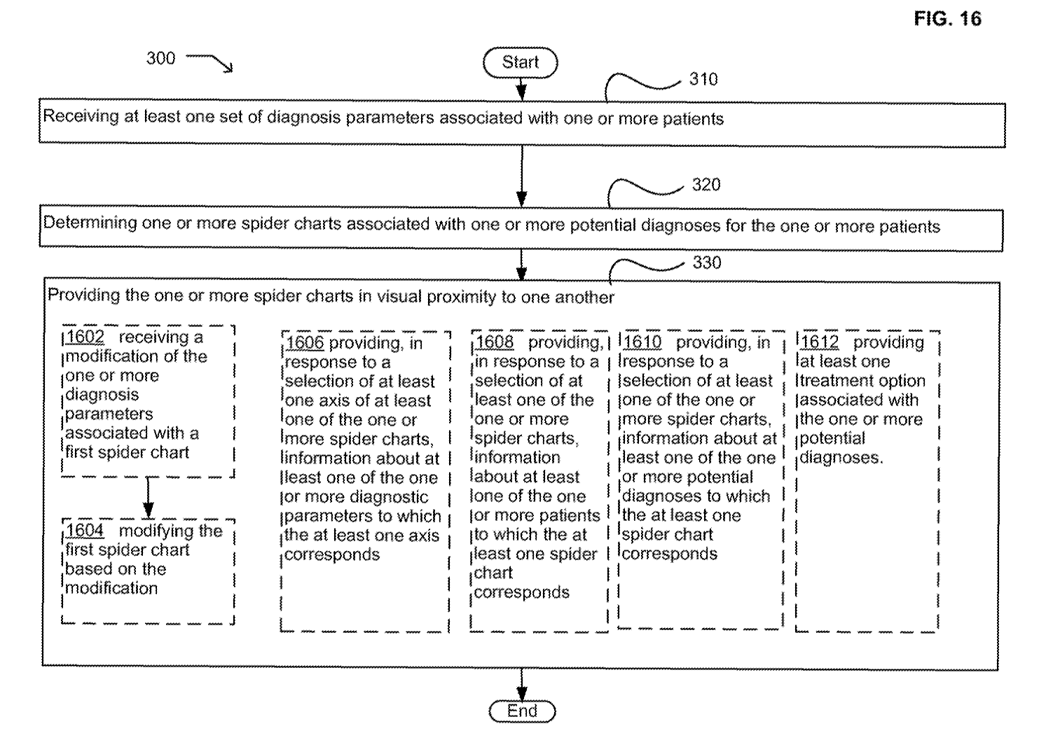

FIG. 16 illustrates alternative embodiments of the example operational flow 300 of FIG. 3. FIG. 16 illustrates example embodiments where the providing operation 330 may include at least one additional operation. Additional operations may include an operation 1602, an operation 1604, an operation 1606, an operation 1608, an operation 1610, and/or an operation 1612

At an operation 1602, a modification of the one or more diagnosis parameters associated with a first spider chart may be received. For example, the parameter handler 116 may receive a modification of the spider chart 110a. For example, the clinician 104 may wish to make a correction or express a new/modified value for a diagnosis parameter. The clinician 104 may then modify the spider chart 110a, e.g., by dragging-and-dropping the modified parameter along its associated axis, or by entering a new value for the parameter using the input fields 112. At an operation 1604, the first spider chart may be modified based on the modification. For example, the view generator 126, perhaps based on input from the spider chart generator 118, may re-provide the spider chart 110a with the updated value(s) for the relevant diagnosis parameter(s).

At the operation 1606, in response to a selection of at least one axis of at least one of the one or more spider charts, information may be provided about at least one of the one or more diagnostic parameters to which the at least one axis corresponds. For example, the parameter handler 116 may receive a selection of the axis “a” of the spider chart 110a, which may correspond to any of the diagnosis parameters described herein, or other diagnosis parameters. The view generator 126 may then provide additional information (e.g., in a pop-up window of the user interface 108) regarding that diagnosis parameter. For example, if the axis “a” corresponds to a temperature of the patient 106, then the clinician 104 may, in this manner, determine information such as how long the patient has had a fever and what the patient's highest fever has been during a current illness.

At the operation 1608, in response to a selection of at least one of the one or more spider charts, information may be provided about at least one of the one or more patients to which the at least one spider chart corresponds. For example, the parameter handler 116 may receive a selection of the spider chart 110a, which may correspond to the patient 106. The view generator 126 may then provide additional information (e.g., in a pop-up window of the user interface 108) regarding patient 106. For example, if the spider chart 110a is related to physical symptoms of the patient 106, then selecting the spider chart may allow the clinician 104 with additional information about the patient 106, such as a family or surgical history. In some implementations, this additional information may itself be provided by the view generator 126 in the form of one or more spider charts (e.g., within the pop-up window).

At the operation 1610, in response to a selection of at least one of the one or more spider charts, information may be provided about at least one of the one or more potential diagnoses to which the at least one spider chart corresponds. For example, the parameter handler 116 may receive a selection of the spider chart 110b, which may correspond to a diagnosis of pneumonia. The view generator 126 may then provide additional information (e.g., in a pop-up window of the user interface 108) regarding the diagnosis of pneumonia. For example, such information may include risk factors, additional information to solicit from the relevant patient, treatment options, or other information that may be useful in diagnosing or otherwise treating the patient 106.

At the operation 1612, at least one treatment option associated with the one or more potential diagnoses may be provided. For example, the view generator 126 may provide the treatment options 114 in the user interface 108 for one or more of the potential diagnoses associated, for example, with spider charts 110b, 110c. Such treatment options may include, for example, proposed tests, medications, surgeries or other procedures, rehabilitations, or any virtually other curative or palliative action that the clinician 104 may wish to take in the event that the patient 106 suffers from a particular ailment.

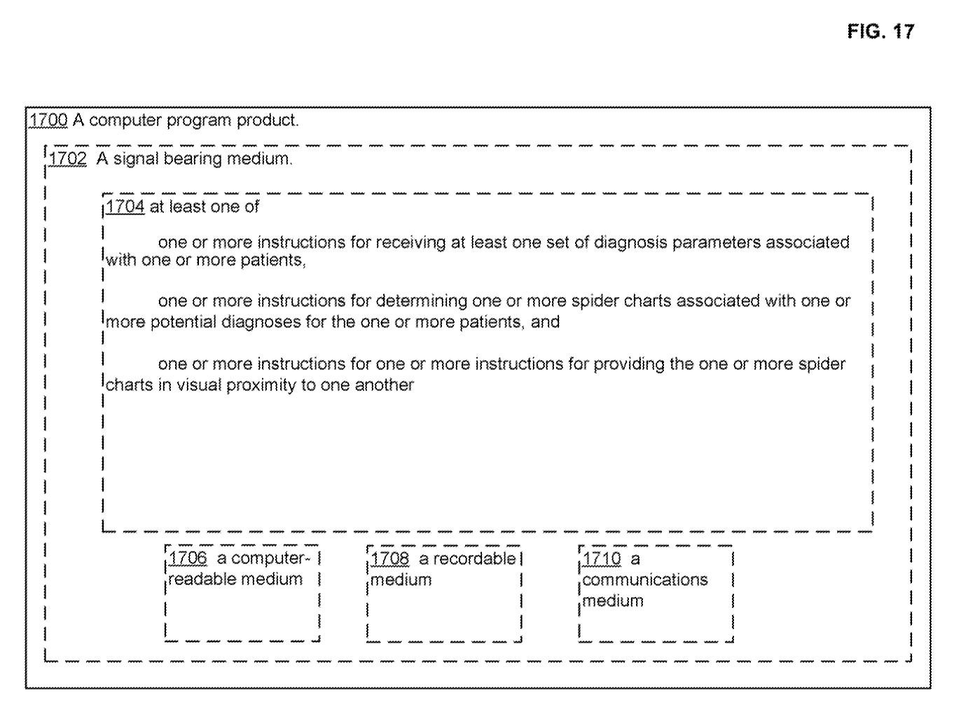

FIG. 17 illustrates a partial view of an example computer program product 1700 that includes a computer program 1704 for executing a computer process on a computing device. An embodiment of the example computer program product 1700 is provided using a signal bearing medium 1702, and may include one or more instructions for receiving at least one set of diagnosis parameters associated with one or more patients 1704. The signal bearing medium 1702 also may bear one or more instructions for determining one or more spider charts associated with one or more potential diagnoses for the one or more patients 1704. The signal bearing medium 1702 also may bear one or more instructions for providing the one or more spider charts in visual proximity to one another 1704.

The one or more instructions may be, for example, computer executable and/or logic-implemented instructions. In one implementation, the signal-bearing medium 1702 may include a computer-readable medium 1706. In one implementation, the signal bearing medium 1702 may include a recordable medium 1708. In one implementation, the signal bearing medium 1702 may include a communications medium 1710.

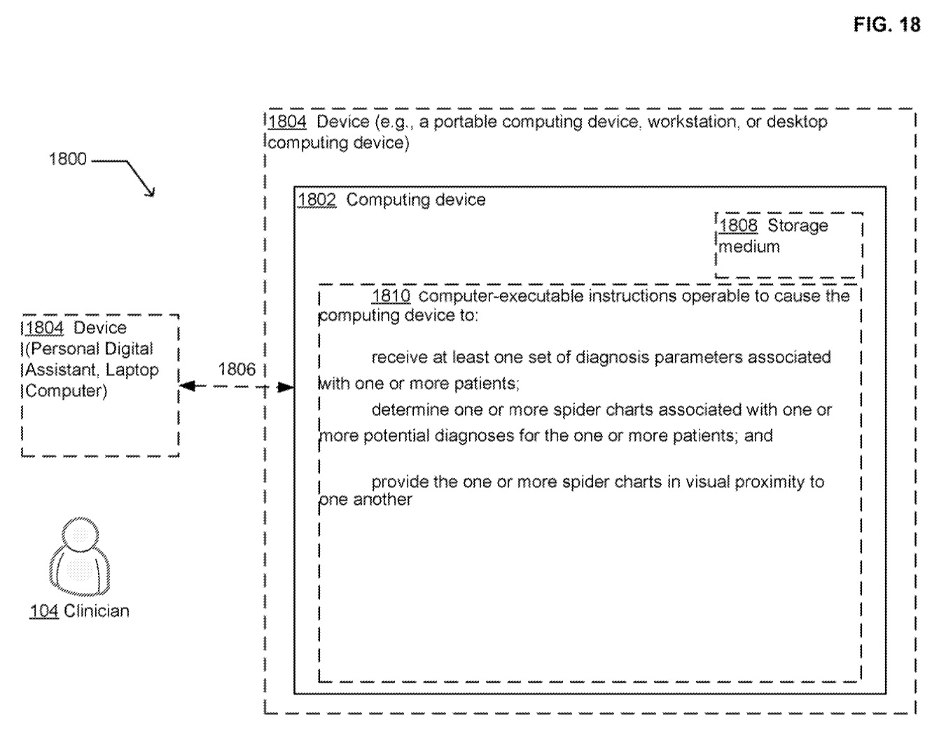

FIG. 18 illustrates an example system 1800 in which embodiments may be implemented. The system 1800 includes a computing system environment. The system 1800 also illustrates the clinician 104 using a device 1804, which is optionally shown as being in communication with a computing device 1802 by way of an optional coupling 1806. The optional coupling 1806 may represent a local, wide-area, or peer-to-peer network, or may represent a bus that is internal to a computing device (e.g., in example embodiments in which the computing device 1802 is contained in whole or in part within the device 1804). A storage medium 1808 may be any computer storage media.

The computing device 1802 includes computer-executable instructions 1810 that when executed on the computing device 1802, cause the computing device 1802 to receive at least one set of diagnosis parameters associated with one or more patients, determine one or more spider charts associated with one or more potential diagnoses for the one or more patients, and provide the one or more spider charts in visual proximity to one another.

In FIG. 18, then, the system 1800 includes at least one computing device (e.g., 1802 and/or 1804). The computer-executable instructions 1810 may be executed on one or more of the at least one computing device. For example, the computing device 1802 may implement the computer-executable instructions 1810 and output a result to (and/or receive data from) the computing (clinician) device 1804. Since the computing device 1802 may be wholly or partially contained within the computing (clinician) device 1804 the computing (clinician) device 1804 also may be said to execute some or all of the computer-executable instructions 1810, in order to be caused to perform or implement, for example, various ones of the techniques described herein, or other techniques.

The clinician device 1804 may include, for example, one or more of a personal digital assistant (PDA), a laptop computer, a tablet personal computer, a networked computer, a computing system comprised of a cluster of processors, a workstation computer, and/or a desktop computer. In another example embodiment, the clinician device 1804 may be operable to communicate with the computing device 1802 to communicate with a database (e.g., implemented using the storage medium 1808) to access diagnosis parameters, spider charts, or other relevant information.

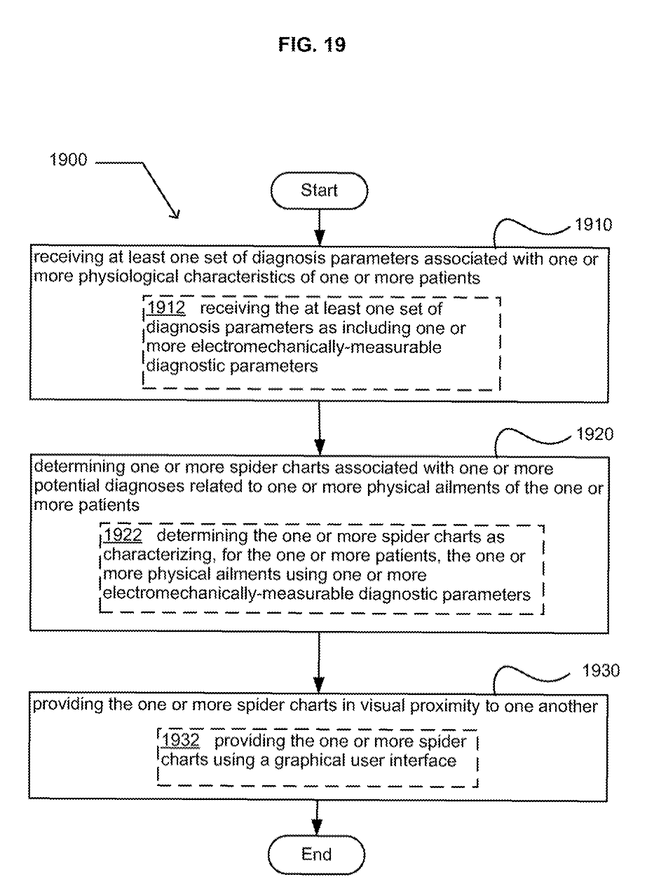

FIG. 19 illustrates another example operational flow representing example operations related to diagnosis through graphical representations of patient characteristics. In FIG. 19 and in following figures that include various examples of operational flows, discussion and explanation may be provided with respect to the above-described examples of FIGS. 1 and 2, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 1900 moves to a receiving operation 1910, where at least one set of diagnosis parameters associated with one or more physiological characteristics of one or more patients may be received. For example, the parameter handler 116 may receive one or more diagnosis parameters associated with one or more physiological characteristics of the patient 106, either by way of the input fields 112 of the user interface 108, and/or by way of the sensors 117.

In a determining operation 1920, one or more spider charts associated with one or more potential diagnoses related to one or more physical ailments of the one or more patients may be determined. For example, the spider chart generator 118 may determine the spider charts 110a, 110b, 110c. As described, the spider charts 110a, 110b, 110c may be associated with the patient 106 and possibly other patients, and/or may be associated with a potential diagnosis for one or more of the patient(s) that is related to a physical (e.g., as opposed to a mental) ailment of the patient 106.

In a providing operation 1930, the one or more spider charts may be provided in visual proximity to one another. For example, the view generator 126 may be configured to provide the spider charts 110a, 110b, 110c in visual proximity to one another within the user interface 108.

FIG. 19 also illustrates alternative embodiments of the example operational flow 1900 of FIG. 19. Thus, FIG. 19 illustrates example embodiments where the receiving operation 1910 may include at least one additional operation (e.g., the operation 1912), and the determining operation 1920 may include at least one additional operation (e.g., the operation 1922), and the providing operation 1930 may include at least one additional operation (e.g., the operation 1932).

For example, at the operation 1912, the at least one set of diagnosis parameters may be received as including one or more electromechanically-measurable diagnostic parameters. For example, such diagnostic parameters may include those that may be detected, measured, or otherwise determined directly by electro-mechanical techniques (e.g., using the sensor 117). At the operation 1922, the one or more spider charts may be determined as characterizing, for the one or more patients, the one or more physical ailments using one or more electromechanically-measurable diagnostic parameters. For example, the spider chart generator 118 may determine the spider chart 110a based on a physical ailment of the patient 106, which may be captured at least in part by way of the sensor 117. Finally in FIG. 19, at the operation 1932, the one or more spider charts may be provided using a graphical user interface. For example, as described, the view generator 126 may provide the spider chart 110a using the graphical user interface 108.

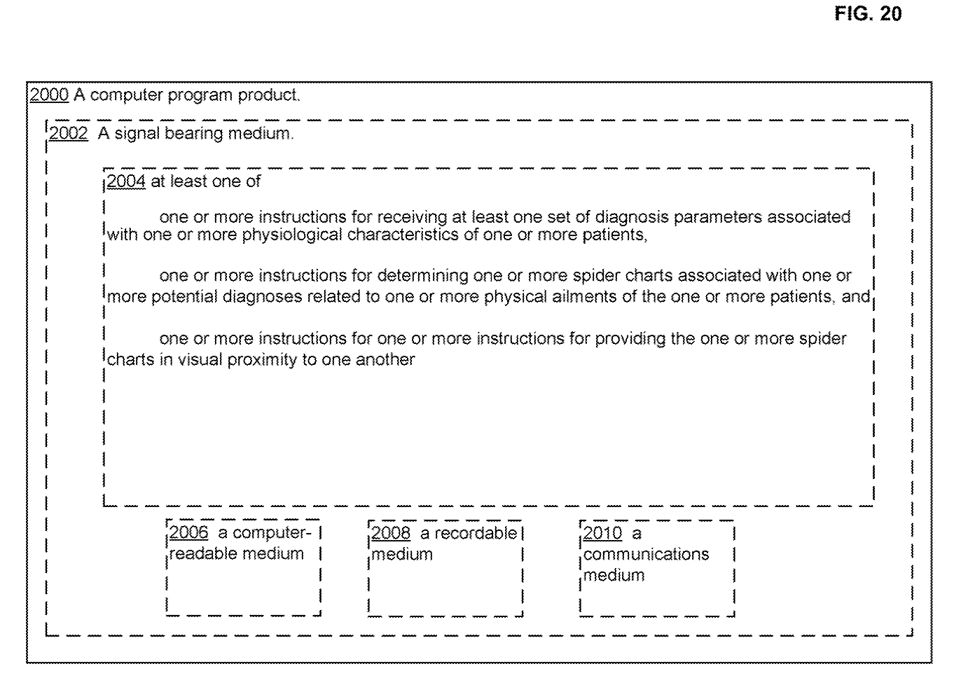

FIG. 20 illustrates a partial view of an example computer program product that includes a computer program for executing a computer process on a computing device. FIG. 20 illustrates a partial view of an example computer program product 2000 that includes a computer program 2004 for executing a computer process on a computing device. An embodiment of the example computer program product 2000 is provided using a signal bearing medium 2002, and may include one or more instructions for receiving at least one set of diagnosis parameters associated with one or more physiological characteristics of one or more patients. The signal bearing medium 2002 also may bear one or more instructions for determining one or more spider charts associated with one or more potential diagnoses related to one or more physical ailments of the one or more patients. The signal bearing medium 2002 also may bear one or more instructions for providing the one or more spider charts in visual proximity to one another.

The one or more instructions may be, for example, computer executable and/or logic-implemented instructions. In one implementation, the signal-bearing medium 2002 may include a computer-readable medium 2006. In one implementation, the signal bearing medium 2002 may include a recordable medium 2008. In one implementation, the signal bearing medium 2002 may include a communications medium 2010.

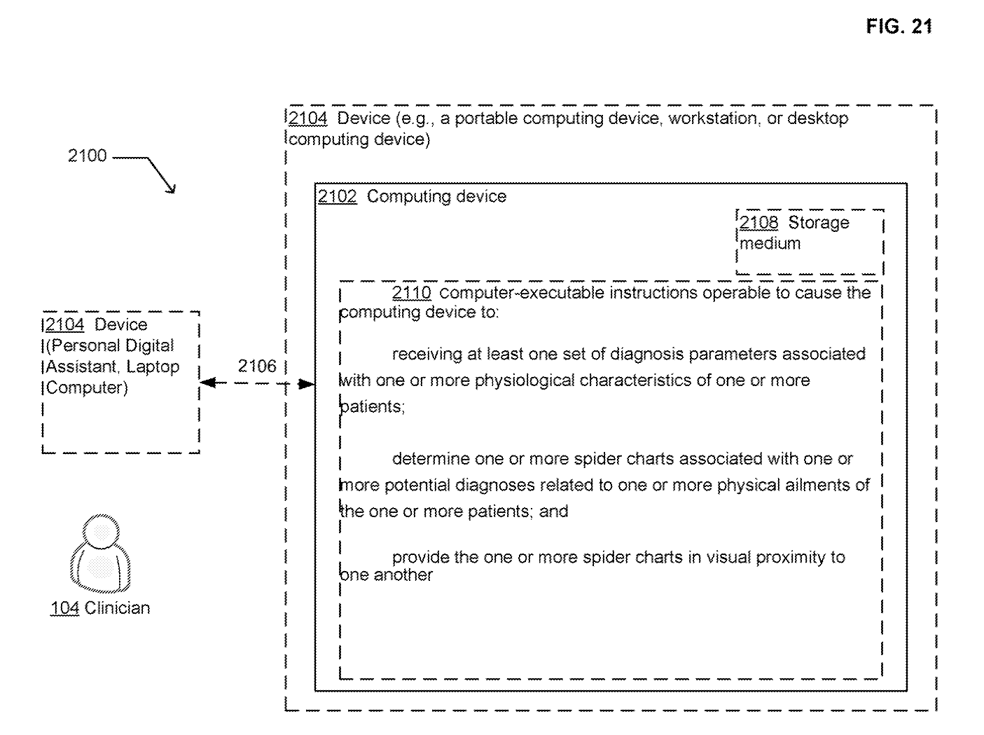

FIG. 21 illustrates an example system in which embodiments may be implemented. FIG. 21 illustrates an example system 2100 in which embodiments may be implemented. The system 2100 includes a computing system environment. The system 2100 also illustrates the clinician 104 using a device 2104, which is optionally shown as being in communication with a computing device 2102 by way of an optional coupling 2106. The optional coupling 2106 may represent a local, wide-area, or peer-to-peer network, or may represent a bus that is internal to a computing device (e.g., in example embodiments in which the computing device 2102 is contained in whole or in part within the device 2104). A storage medium 2108 may be any computer storage media.

The computing device 2102 includes computer-executable instructions 2110 that when executed on the computing device 2102, cause the computing device 2102 to receive at least one set of diagnosis parameters associated with one or more physiological characteristics of one or more patients, determine one or more spider charts associated with one or more potential diagnoses related to one or more physical ailments of the one or more patients, and provide the one or more spider charts in visual proximity to one another.

In FIG. 21, then, the system 2100 includes at least one computing device (e.g., 2102 and/or 2104). The computer-executable instructions 2110 may be executed on one or more of the at least one computing device. For example, the computing device 2102 may implement the computer-executable instructions 2110 and output a result to (and/or receive data from) the computing (clinician) device 2104. Since the computing device 2102 may be wholly or partially contained within the computing (clinician) device 2104 the computing (clinician) device 2104 also may be said to execute some or all of the computer-executable instructions 2110, in order to be caused to perform or implement, for example, various ones of the techniques described herein, or other techniques.

The clinician device 2104 may include, for example, one or more of a personal digital assistant (PDA), a laptop computer, a tablet personal computer, a networked computer, a computing system comprised of a cluster of processors, a workstation computer, and/or a desktop computer. In another example embodiment, the clinician device 2104 may be operable to communicate with the computing device 2102 to communicate with a database (e.g., implemented using the storage medium 2108) to access relevant data, e.g., stored diagnosis parameters and/or spider charts.

The following reference(s) are hereby incorporated by reference in their entirety to the extent such is not inconsistent herewith:

List of ICD-9 codes 001-139: Infectious and parasitic diseases:
http://en.wikipedia.org/wiki/List_of_ICD-9_codes_001-139:_Infectious_and_parasitic_diseases
List of ICD-9 codes 140-239: Neoplasms:
http://en.wikipedia.org/wiki/List_of_ICD-9_codes_140-239:_Neoplasms
List of ICD-9 codes 240-279: Endocrine, nutritional and metabolic diseases, and
immunity disorders:
http://en.wikipedia.org/wiki/List_of_ICD-9_codes_240-279:_Endocrine%2C_nutritional_and_metabolic_diseases%2C_and_immunity_disorders
List of ICD-9 codes 280-289: Diseases of the blood and blood-forming organs:
http://en.wikipedia.org/wiki/List_of_ICD-9_codes_280-289:_Diseases_of_the_blood_and_blood-forming_organs
List of ICD-9 codes 290-319: Mental disorders:
http://en.wikipedia.org/wiki/List_of_ICD-9_codes_290-319:_Mental_disorders
List of ICD-9 codes 320-359: Diseases of the nervous system:
http://en.wikipedia.org/wiki/List_of_ICD-9_codes_320-359:_Diseases_of_the_nervous_system
List of ICD-9 codes 360-389: Diseases of the sense organs:
http://en.wikipedia.org/wiki/List_of_ICD-9_codes_360-389:_Diseases_of_the_sense_organs
List of ICD-9 codes 390-459: Diseases of the circulatory system:
http://en.wikipedia.org/wiki/List_of_ICD-9_codes_390-459:_Diseases_of_the_circulatory_system
List of ICD-9 codes 460-519: Diseases of the respiratory system:
http://en.wikipedia.org/wiki/List_of_ICD-9_codes_460-519:_Diseases_of_the_respiratory_system
List of ICD-9 codes 520-579: Diseases of the digestive system:
http://en.wikipedia.org/wiki/List_of_ICD-9_codes_520-579:_Diseases_of_the_digestive_system
List of ICD-9 codes 580-629: Diseases of the genitourinary system:
http://en.wikipedia.org/wiki/List_of_ICD-9_codes_580-629:_Diseases_of_the_genitourinary_system
List of ICD-9 codes 630-676: Complications of pregnancy, childbirth, and the
puerperium: http://en.wikipedia.org/wiki/List_of_ICD-9_codes_630-676:_Complications_of_pregnancy%2C_childbirth%2C_and_the_puerperium
List of ICD-9 codes 680-709: Diseases of the skin and subcutaneous tissue:
http://en.wikipedia.org/wiki/List_of_ICD-9_codes_680-709:_Diseases_of_the_skin_and_subcutaneous_tissue
List of ICD-9 codes 710-739: Diseases of the musculoskeletal system and
connective tissue: http://en.wikipedia.org/wiki/List_of_ICD-9_codes_710-739:_Diseases_of_the_musculoskeletal_system_and_connective_tissue
List of ICD-9 codes 740-759: Congenital anomalies:
http://en.wikipedia.org/wiki/List_of_ICD-9_codes_740-759:_Congenital_anomalies
List of ICD-9 codes 760-779: Certain conditions originating in the perinatal
period: http://en.wikipedia.org/wiki/List_of_ICD-9_codes_760-779:_Certain_conditions_originating_in_the_perinatal_period
List of ICD-9 codes 780-799: Symptoms, signs, and ill-defined conditions:
http://en.wikipedia.org/wiki/List_of_ICD-9_codes_780-799:_Symptoms%2C_signs%2C_and_ill-defined_conditions
List of ICD-9 codes 800-999: Injury and poisoning:
http://en.wikipedia.org/wiki/List_of_ICD-9_codes_800-999:_Injury_and_poisoning
List of ICD-9 codes E and V codes: External causes of injury and supplemental
classification: http://en.wikipedia.org/wiki/List_of_ICD-9_codes_E_and_V_codes:_External_causes_of_injury_and_supplemental_classification
Lippincott, Williams, & Wilkins, Clinical Laboratory Medicine (second edition),
Philadelphia, PA (2002))
Bickley et al., Bates' Guide to Physical Examination And History Taking (9th
Edition)
Kasper, Harrison's Principles of Internal Medicine (Hardcover)
Grainger et al., Grainger & Allison's Diagnostic Radiology: A Textbook of
Medical Imaging (3-Volume Set)
Brant et al., The Brant and Helms Solution: Fundamentals of Diagnostic
Radiology, Third Edition, Plus Integrated Content Website (4 vol. set)
Townsend, Sabiston Textbook of Surgery
First et al., DSM-IV-TR Handbook of Differential Diagnosis (Paperback)
Youmans Neurological Surgery: A Comprehensive Reference Guide to the
Diagnosis and Management of Neurosurgical Problems (5-Volume Set)
Ropper et al., Adams and Victor's Principles of Neurology (8th Edition)

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1. A method comprising:
receiving at least one set of diagnosis parameters associated with one or more patients;
determining one or more spider charts associated with one or more potential diagnoses for the one or more patients; and
providing the one or more spider charts in visual proximity to one another.

2. The method of claim 1 wherein receiving at least one set of diagnosis parameters associated with one or more patients comprises:
receiving a patient-specific set of diagnosis parameters for a single patient to be diagnosed.

3. The method of claim 1 wherein receiving at least one set of diagnosis parameters associated with one or more patients comprises:
receiving a plurality of sets of patient-specific diagnosis parameters associated with a plurality of patients to be diagnosed relative to one another.

4-46. (canceled)

47. The method of claim 1 wherein providing the one or more spider charts in visual proximity to one another comprises:
providing at least a first spider chart of the one or more spider charts as being associated with at least a first patient of the one or more patients; and
providing at least a second spider chart of the one or more spider charts as being associated with the one or more potential diagnoses.

48. The method of claim 1 wherein providing the one or more spider charts in visual proximity to one another comprises:
providing a first spider chart of the one or more spider charts as having a first plurality of axes connected at a first central point, and having a first set of the one or more sets of diagnosis parameters plotted on the first plurality of axes; and
providing a second spider chart of the one or more spider charts as having a second plurality of axes connected at a second central point, and having a second set of the one or more sets of diagnosis parameters plotted on the second plurality of axes.

49-61. (canceled)

62. A system comprising:
means for receiving at least one set of diagnosis parameters associated with one or more patients;
means for determining one or more spider charts associated with one or more potential diagnoses for the one or more patients; and
means for providing the one or more spider charts in visual proximity to one another.

63. The system of claim 62 wherein means for receiving at least one set of diagnosis parameters associated with one or more patients comprises:
means for receiving a patient-specific set of diagnosis parameters for a single patient to be diagnosed.

64. The system of claim 62 wherein means for receiving at least one set of diagnosis parameters associated with one or more patients comprises:
means for receiving a plurality of sets of patient-specific diagnosis parameters associated with a plurality of patients to be diagnosed relative to one another.

65. The system of claim 62 wherein means for receiving at least one set of diagnosis parameters associated with one or more patients comprises:
means for receiving at least a portion of the at least one set of diagnosis parameters by way of a graphical user interface.

66. The system of claim 62 wherein means for receiving at least one set of diagnosis parameters associated with one or more patients comprises:
means for receiving at least a portion of the at least one set of diagnosis parameters as a selected subset of a set of diagnosis parameters provided by a graphical user interface.

67. The system of claim 62 wherein means for receiving at least one set of diagnosis parameters associated with one or more patients comprises:
means for receiving at least a portion of the at least one set of diagnosis parameters based on a received selection of a portion of a graphical representation of the one or more patients.

68. The system of claim 62 wherein means for receiving at least one set of diagnosis parameters associated with one or more patients comprises:
means for receiving at least a portion of the at least one set of diagnosis parameters from at least one sensor.

69. The system of claim 62 wherein means for receiving at least one set of diagnosis parameters associated with one or more patients comprises:
means for receiving at least a portion of the at least one set of diagnosis parameters and providing the one or more potential diagnoses in response thereto.

70. The system of claim 62 wherein means for receiving at least one set of diagnosis parameters associated with one or more patients comprises:
means for receiving at least a portion of the at least one set of diagnosis parameters and removing one or more of the received at least a portion of the set of diagnosis parameters.

71-84. (canceled)

85. The system of claim 62 wherein means for determining one or more spider charts associated with one or more potential diagnoses for the one or more patients comprises:
means for determining a corresponding spider chart for each of the at least one set of diagnosis parameters.

86. The system of claim 62 wherein means for determining one or more spider charts associated with one or more potential diagnoses for the one or more patients comprises:
means for determining the one or more spider charts as including a plurality of axes that are each attached to a center point, each axis corresponding to at least one of the diagnosis parameters.

87. The system of claim 62 wherein means for determining one or more spider charts associated with one or more potential diagnoses for the one or more patients comprises:
means for determining the one or more spider charts as including a plurality of axes that are each attached to a center point, each axis corresponding to at least one of the one or more potential diagnoses.

88. The system of claim 62 wherein means for determining one or more spider charts associated with one or more potential diagnoses for the one or more patients comprises:
means for determining the one or more spider charts as including a plurality of axes, each axis corresponding to at least one of the diagnosis parameters, with a value for each diagnosis parameter plotted on a corresponding axis.

89. The system of claim 62 wherein means for determining one or more spider charts associated with one or more potential diagnoses for the one or more patients comprises:
means for determining the one or more spider charts as including a plurality of axes, each axis corresponding to at least one of the one or more potential diagnoses, with a value for each potential diagnoses plotted on a corresponding axis.

90. The system of claim 62 wherein means for determining one or more spider charts associated with one or more potential diagnoses for the one or more patients comprises:
means for plotting a first set of the at least one set of diagnosis parameters by designating values for corresponding diagnostic parameters of the first set along corresponding axes of a corresponding first spider chart; and
means for providing a visual designation of the values as being associated with the first set.

91. The system of claim 62 wherein means for determining one or more spider charts associated with one or more potential diagnoses for the one or more patients comprises:
means for determining a first spider chart of the one or more spider charts as being associated with a first patient; and
means for determining a second spider chart of the one or more spider charts as being associated with a second patient.

92. The system of claim 62 wherein means for determining one or more spider charts associated with one or more potential diagnoses for the one or more patients comprises:
means for determining a first spider chart of the one or more spider charts as being associated with a first patient at a first time; and
means for determining a second spider chart of the one or more spider charts as being associated with the first patient at a second time.

93. The system of claim 62 wherein means for determining one or more spider charts associated with one or more potential diagnoses for the one or more patients comprises:
means for determining at least one predicted diagnosis for the one or more patients, based on the at least one set of diagnosis parameters.

94. The system of claim 62 wherein means for determining one or more spider charts associated with one or more potential diagnoses for the one or more patients comprises:
means for determining at least one predicted diagnosis for the one or more patients, based on a Boolean combination of the at least one set of diagnosis parameters.

95. The system of claim 62 wherein means for determining one or more spider charts associated with one or more potential diagnoses for the one or more patients comprises:
means for determining at least one predicted diagnosis for the one or more patients, based on at least one combination of at least a portion of the at least one set of diagnosis parameters.

96. The system of claim 62 wherein means for determining one or more spider charts associated with one or more potential diagnoses for the one or more patients comprises:
means for determining a first spider chart of the one or more spider charts as being associated with a first patient; and
determining a second spider chart of the one or more spider charts as being associated with the one or more potential diagnoses.

97. The system of claim 62 wherein means for determining one or more spider charts associated with one or more potential diagnoses for the one or more patients comprises:
means for determining a first spider chart of the one or more spider charts as being associated with a first patient; and
means for determining a plurality of spider charts, each of the plurality of spider charts associated with a different one of the one or more potential diagnoses for the first patient.

98-105. (canceled)

106. The system of claim 62 wherein means for providing the one or more spider charts in visual proximity to one another comprises:
means for providing the one or more spider charts, each associated with at least one of the one or more patients;
means for determining that at least one of the one or more diagnostic parameters is altered from a normative value; and
means for providing a visual indicator in association with a spider chart of the one or more spider charts containing the at least one of the one or more diagnostic parameters.

107. The system of claim 62 wherein means for providing the one or more spider charts in visual proximity to one another comprises:
means for providing a first spider chart of the one or more spider charts as being associated with a first patient of the one or more patients and having a first visual characteristic;
means for providing a second spider chart of the one or more spider charts as being associated with a second patient of the one or more patients and having a second visual characteristic.

108. The system of claim 62 wherein means for providing the one or more spider charts in visual proximity to one another comprises:
means for providing at least a first spider chart of the one or more spider charts as being associated with at least a first patient of the one or more patients; and
means for providing at least a second spider chart of the one or more spider charts as being associated with the one or more potential diagnoses.

109. The system of claim 62 wherein means for providing the one or more spider charts in visual proximity to one another comprises:
means for providing a first spider chart of the one or more spider charts as having a first plurality of axes connected at a first central point, and having a first set of the one or more sets of diagnosis parameters plotted on the first plurality of axes; and
means for providing a second spider chart of the one or more spider charts as having a second plurality of axes connected at a second central point, and having a second set of the one or more sets of diagnosis parameters plotted on the second plurality of axes.

110. The system of claim 62 wherein means for providing the one or more spider charts in visual proximity to one another comprises:
means for providing a spider chart of the one or more spider charts as having a plurality of axes connected at a central point;
means for providing a first set of the one or more sets of diagnosis parameters plotted on the plurality of axes; and
means for providing a second set of the one or more sets of diagnosis parameters plotted on the plurality of axes.

111. (canceled)

112. The system of claim 62 wherein means for providing the one or more spider charts in visual proximity to one another comprises:
means for providing the one or more spider charts on a graphical user interface as being selectable for comparison of a first spider chart of the one or more spider charts to a second spider chart of the one or more spider charts.

113. (canceled)

114. The system of claim 62 wherein means for providing the one or more spider charts in visual proximity to one another comprises:
means for receiving a modification of the one or more diagnosis parameters associated with a first spider chart; and
means for modifying the first spider chart based on the modification.

115. The system of claim 62 wherein means for providing the one or more spider charts in visual proximity to one another comprises:
means for providing, in response to a selection of at least one axis of at least one of the one or more spider charts, information about at least one of the one or more diagnostic parameters to which the at least one axis corresponds.

116. The system of claim 62 wherein means for providing the one or more spider charts in visual proximity to one another comprises:
means for providing, in response to a selection of at least one of the one or more spider charts, information about at least one of the one or more patients to which the at least one spider chart corresponds.

117. The system of claim 62 wherein means for providing the one or more spider charts in visual proximity to one another comprises:
means for providing, in response to a selection of at least one of the one or more spider charts, information about at least one of the one or more potential diagnoses to which the at least one spider chart corresponds.

118. The system of claim 62 wherein means for providing the one or more spider charts in visual proximity to one another comprises:
means for providing at least one treatment option associated with the one or more potential diagnoses.

119. A system comprising:
a computing device including computer-executable instructions that when executed on the computing device, cause the computing device to receive at least one set of diagnosis parameters associated with one or more patients;
determine one or more spider charts associated with one or more potential diagnoses for the one or more patients; and
provide the one or more spider charts in visual proximity to one another.

120. (canceled)

121. A diagnosis system, the diagnosis system comprising:
(a) a parameter handler configured to receive at least one set of diagnosis parameters associated with one or more patients;
(b) a spider chart generator configured to determine one or more spider charts associated with one or more potential diagnoses for the one or more patients; and
(c) a view generator configured to provide the one or more spider charts in visual proximity to one another.

122. (canceled)

123. The diagnosis system of claim 121 wherein the spider chart generator is configured to determine the one or more spider charts associated with one or more potential diagnoses for the one or more patients by determining the one or more spider charts as including a plurality of axes that are each attached to a center point, each axis corresponding to at least one of the diagnosis parameters.

124-132. (canceled)

133. A system comprising:
means for receiving at least one set of diagnosis parameters associated with one or more physiological characteristics of one or more patients;
means for determining one or more spider charts associated with one or more potential diagnoses related to one or more physical ailments of the one or more patients; and
means for providing the one or more spider charts in visual proximity to one another.

134. The system of claim 133 wherein means for receiving at least one set of diagnosis parameters associated with one or more physiological characteristics of one or more patients comprises:
means for receiving the at least one set of diagnosis parameters as including one or more electromechanically-measurable diagnostic parameters.

135. The system of claim 133 wherein means for determining one or more spider charts associated with one or more potential diagnoses related to one or more physical ailments of the one or more patients comprises:
means for determining the one or more spider charts as characterizing, for the one or more patients, the one or more physical ailments using one or more electromechanically-measurable diagnostic parameters.

136-142. (canceled)
